(19) United States
(12) Patent Application Publication
(10) Pub. No.: US 2012/0320277 A1
(43) Pub. Date: Dec. 20, 2012

(54) DISPLAY DEVICE AND TELEVISION RECEIVER

(75) Inventor: Yoshiki Takata, Osaka-shi (JP)

(73) Assignee: SHARP KABUSHIKI KAISHA, Osaka-shi, Osaka (JP)

(21) Appl. No.: 13/515,505

(22) PCT Filed: Nov. 9, 2010
(86) PCT No.: PCT/JP10/69900

§ 371 Date: Sep. 4, 2012

(30) Foreign Application Priority Data
Dec. 16, 2009 (JP) 2009-285583

(51) Int. Cl. H04N 5/44; G09G 5/10

(52) U.S. Cl. 348/725; 345/690; 348/E05.096

(57) ABSTRACT

In a display device, the chromaticity of display images is properly corrected while the brightness is maintained at a high level. A liquid crystal display device 10 according to the present invention includes a liquid crystal panel 11 and a backlight unit 12. The liquid crystal panel 11 includes a pair of substrates 11a and 11b and a liquid crystal layer 11c containing substances having optical characteristics that varies according to an application of electric field. The backlight unit 12 is a lighting unit configured to illuminate the liquid crystal panel 11. On a CF substrate 11a of the pair of substrates 11a and 11b, color filters 19 including R, G, B, Y color portions in red, green, blue and yellow, respectively, are formed. The backlight unit 12 includes LEDs 24 as light sources.

### TECHNICAL FIELD

The present invention relates to a display device and a television receiver.

### BACKGROUND ART

A liquid crystal panel that is a main component of a liquid crystal display device includes a pair of glass substrates and liquid crystals sealed between the glass substrates. One of the glass substrates is an array substrate on which TFTs are arranged. The TFTs are active elements. The other glass substrate is a CF substrate on which color filters are arranged. On an inner surface of the CF substrate opposite the array substrate, color filters including a plurality of color portions in red, green and blue arranged according to pixels of the array board. Light blocking layers are arranged between the color portions so that colors are not mixed. Light emitted from a backlight unit and passed through the liquid crystals. The red, the green and the blue color portions of the color filters selectively pass light in specific wavelengths corresponding to the colors. As a result, images are displayed on the liquid crystal panel.

To improve the display quality of the liquid crystal display device, an improvement in color reproducibility may be effective. For the improvement, color portions of the color filters may be provided in another color such as cyan (or greenish blue) in addition to the three primary colors of light, which are red, green and blue. An example is disclosed in Patent Document 1.
Patent Document 1: Japanese Unexamined Patent Publication No. 2006-58332

### Problem to be Solved by the Invention

When the portions of the color filters are provided in another color in addition to the three primary colors of light, display images is more likely to be affected by the added color. To reduce such an effect, amounts of light passing through the color portions may be controlled through TFTs driven for respective pixels of a liquid crystal panel. With this configuration, chromaticity of the display images can be corrected. However, the amounts of light passing through the color portions tend to decrease according to the correction of the chromaticity. Therefore, brightness may decrease.

In view of such a problem, the inventor of this application has reached an idea. Namely, the inventor has assumed that chromaticity of display images can be corrected without a reduction in brightness by adjusting chromaticity of light sources in a backlight unit for illuminating a liquid crystal panel. Furthermore, a color added to multiple primary color-type liquid crystal panel other than three primary colors may be different from cyan. In chromaticity adjustment, what type of light sources is preferable has not been sufficiently examined.

### DISCLOSURE OF THE PRESENT INVENTION

The present invention was made in view of the foregoing circumstances. An object of the present invention is to properly correct chromaticity of display images while brightness is maintained at a high level.

### Means for Solving the Problem

To solve the above problem, a display device according to this invention includes a display panel, a lighting unit configured to illuminate the display panel, and color filters formed on one of the substrates. The display panel includes a pair of substrates and a substance having optical characteristics that vary according to an application of electric field and arranged between the substrates. The color filters include a plurality of color portions in blue, green, red and yellow, respectively. The lighting unit includes LEDs as light sources.

The color filters including the color portion in yellow in addition to the color portions in blue, green and red that are three primary colors of light are formed on one of the substrates of the display panel. With this configuration, a color reproduction range, colors in which are perceivable to human eyes, can be expanded, that is, the color gamut can be expanded. Furthermore, reproducibility of colors of objects in nature can be enhanced and thus display quality can be improved. Light exiting from the color portion in yellow among the color portions of the color filters has a wavelength close to the visible peak. Namely, people perceive the light as bright light even though the light is emitted with low energy. Even when the outputs of the light sources are reduced, sufficient brightness still can be achieved. Therefore, the power consumption of the light sources can be reduced and the lighting unit is provided with high environmental efficiency. Because the high brightness can be achieved as described above, clear contrast can be achieved. Therefore, the display quality can be further improved.

When the color portion in yellow is included in the color filters, the overall color of light exiting from the display panel, that is, the overall color of the display images tend to be yellowish. To solve this problem, the amounts of light passing through the color portions may be controlled and the chromaticity of the display images may be corrected. An overall amount of transmitted light tends to decrease according to the correction of the chromaticity and thus the brightness may decrease. In view of such a problem, the inventor of this application has created a method for correcting the chromaticity of display images without a reduction in brightness by adjusting the chromaticity of light sources in the lighting unit. The LEDs are used as light sources. The LEDs are better with optical characteristics of the display panel in adjustment of chromaticity for correction of chromaticity of display images than cold cathode tubes. Therefore, relatively high brightness can be achieved and thus the chromaticity of display images can be corrected without a reduction in brightness.

The following configuration may be preferable as embodiments of the present invention.

(1) Each LED may include an LED element as a light emitting source and a phosphor configured to emit light exited by light from the LED element. With this configuration, the chromaticity of the LED can be precisely adjusted by adjusting a kind or a content of the phosphor included in the LED as appropriate. Namely, the color portion in yellow can be preferably configured for the display panel.

(2) The LED element may be a blue LED element configured to emit blue light. The phosphor may include a red phosphor and at least one of a green phosphor and a yellow phosphor. The red phosphor may be configured to emit red light excited by the blue light. The green phosphor may be configured to emit green light excited by the blue light. The yellow phosphor may be configured to emit yellow light excited by the blue light. With this configuration, each LED can emit light in specified color using the blue light emitted by the blue LED element, the green light emitted by the green phosphor when excited by the blue light, and the red light emitted by the red phosphor when excited by the blue light. To correct the chromaticity of display images on the display panel having the color portion in yellow in addition to the color portions in three primary colors of light, the color of light from the light sources may be adjusted to be bluish color that is a complementary color of yellow. Each LED may include the blue LED element as a light emitting source. Therefore, the blue light can be emitted with significantly high efficiency. In the adjustment of color of light from the LED to bluish color, the brightness is less likely to decrease and the brightness remains high.

(3) The at least one of the green phosphor and the yellow phosphor may be a SiAlON-based phosphor. The SiAlON-based phosphor, which is nitride, is used for the at least one of the green phosphor and the yellow phosphor. The light can be emitted with high efficiency in comparison to a configuration in which sulfide or oxide is used for the phosphor. Furthermore, the light emitted by the SiAlON-based phosphor has higher chromatic purity in comparison to the YAG-based phosphor. Therefore, the chromaticity of light emitted by the LEDs can be more easily adjusted.

(4) The green phosphor may be β-SiAlON. Green light can be emitted with high efficiency. Furthermore, very high chromatic purity of the green light can be achieved with this configuration. This configuration is significantly effective for adjusting the chromaticity of the LED.

The β-SiAlON contains europium (Eu) as an activator and expressed by Si_{6-z}Al_{z}O_{z}N_{8-z}:Eu, where z is a solid solubility.

(5) The yellow phosphor may be α-SiAlON. Yellow light can be emitted with high efficiency.

The α-SiAlON contains europium (Eu) as an activator and expressed by Mx(Si,Al)₁₂(O,N)₁₆:Eu, where M is metal ion and x is a solid solubility.

(6) The red phosphor may be a CaAlSiN-based phosphor. With this configuration, red light can be emitted with high efficiency in comparison to a configuration in which sulfide or oxide is used for the phosphor.

(7) The CaAlSiN-based phosphor of the red phosphor may be expressed by CaAlSiN₃:Eu. With this configuration, red light can be emitted with high efficiency.

(8) The at least one of the green phosphor and the yellow phosphor may be a YAG-based phosphor. A YAG-based phosphor containing yttrium or aluminum can be used for the at least one of the green phosphor and the yellow phosphor. With this configuration, light can be emitted with high efficiency.

(9) The yellow phosphor may be a BOSE-based phosphor. The BOSE-based phosphor containing barium and strontium can be used for the yellow phosphor.

(10) The lighting unit may include a light guide member made of synthetic resin and arranged opposite an end of each LED. The light guide member may be configured to pass light emitted from the LED and direct the light toward the display panel. A light guide member made of synthetic resin generally has high transparency. However, the light guide member may be slightly yellowish. If so, light emitted by the LEDs passed through the light guide member may become slightly yellowish. In such a case, the chromaticity of the LEDs may be adjusted according to the color of the light guide member in yellowish color in addition to the adjustment by the display panel having the color portion in yellow. As a result, the chromaticity of display images can be properly corrected without a reduction in brightness.

(11) The light guide member may have a longitudinal light entrance surface at an end thereof on an LED side. The LED may have a lens that covers a light emitting side thereof and diffuses light. The lens may be opposite the light entrance surface of the light guide member and curved along a longitudinal direction of the light entrance surface so as to protrude toward the light guide member. With this configuration, light emitted from the LED is spread by the lens in the longitudinal direction of the light entrance surface. Therefore, a dark spot is less likely to be formed on the light entrance surface of the light guide member. Even if a distance between the LED and the light guide member and the number of the LEDs are small, light with uniform brightness enters the light guide member through the entire light entrance surface.

(12) The lighting unit may include a reflection sheet arranged between the LEDs and the light guide member along the longitudinal direction of the light entrance surface. Rays of light scattered by the lenses and travel outside the light guide member are reflected by the reflection sheet, and directed to the light guide member. With this configuration, the efficiency in directing the light emitted by the LEDs to the light guide member can be improved.

(13) The display panel may be a liquid crystal panel including liquid crystals as substances that vary optical characteristics according to an application of electric field. This configuration can be used in various applications including television sets and personal computer displays. This configuration is especially preferable for large-screen applications.

Next, to solve the problems described earlier, a television receiver according to the present invention includes the above display device and a receiver configured to receive television signals.

The display device of the television receiver configured to display television images according to the television signals can properly correct the chromaticity of the display images while the brightness is maintained at a high level. Therefore, the television images can be provided with high display quality.

The television receiver may include an image converter circuit configured to convert the television signals output from the receiver into blue, green, red and yellow image signals. The television signals may be converted into the color signals corresponding to the color portions in blue, green, red and blue, respectively, by the image converter circuit. Therefore, the television images can be displayed with high display quality.

### Advantageous Effect of the Invention

According to the present invention, the chromaticity of display images can be properly corrected while the brightness is maintained at a high level.

### BRIEF DESCRIPTION OF THE DRAWINGS

FIG. 1 is an exploded perspective view illustrating a general construction of a television receiver according to a first embodiment of the present invention.

FIG. 2 is an exploded perspective view illustrating a general construction of a liquid crystal display device included in the television receiver.

FIG. 3 is a cross-sectional view illustrating a cross-sectional configuration of the liquid crystal display device along the long-side direction.

FIG. 4 is a magnified view of an array board illustrating a plan-view configuration.

FIG. 5 is a magnified view of a CF board illustrating a plan-view configuration.

FIG. 6 is a cross-sectional view of the liquid crystal display device along the short-side direction illustrating a cross-sectional configuration.

FIG. 7 is a cross-sectional view of the liquid crystal display device along the long-side direction illustrating a cross-sectional configuration.

FIG. 8 is a magnified perspective view of an LED board.

FIG. 9 is a color space chromaticity diagram created by the International Commission on Illustration (CIE) in 1931.

FIG. 10 is an exploded perspective view of a liquid crystal display device according to a third embodiment.

FIG. 11 is a horizontal cross-sectional view of the liquid crystal display device.

FIG. 12 is an exploded perspective view of a liquid crystal display device according to a fourth embodiment.

FIG. 13 is a plan view illustrating arrangements of diffuser lenses, LED boards, a first reflection sheet, and holding members inside the chassis of the liquid crystal display device.

FIG. 14 is a cross-sectional view of the liquid crystal display device along line xiv-xiv in FIG. 13.

FIG. 15 is a cross-sectional view of the liquid crystal display device along line xv-xv in FIG. 13.

FIG. 16 is a plan view illustrating arrangements of the diffuser lenses, the LED boards, and the holding members in detail.

FIG. 17 is a cross-sectional view along line xvii-xvii in FIG. 16.

FIG. 18 is a cross-sectional view along line xviii-xviii in FIG. 16.

FIG. 19 is a magnified plan view illustrating a plan-view configuration of a CF substrate according to another embodiment (1) of the present invention.

FIG. 20 is a magnified plan view illustrating a plan-view configuration of a CF substrate according to another embodiment (2) of the present invention.

### MODE FOR CARRYING OUT THE INVENTION

### First Embodiment

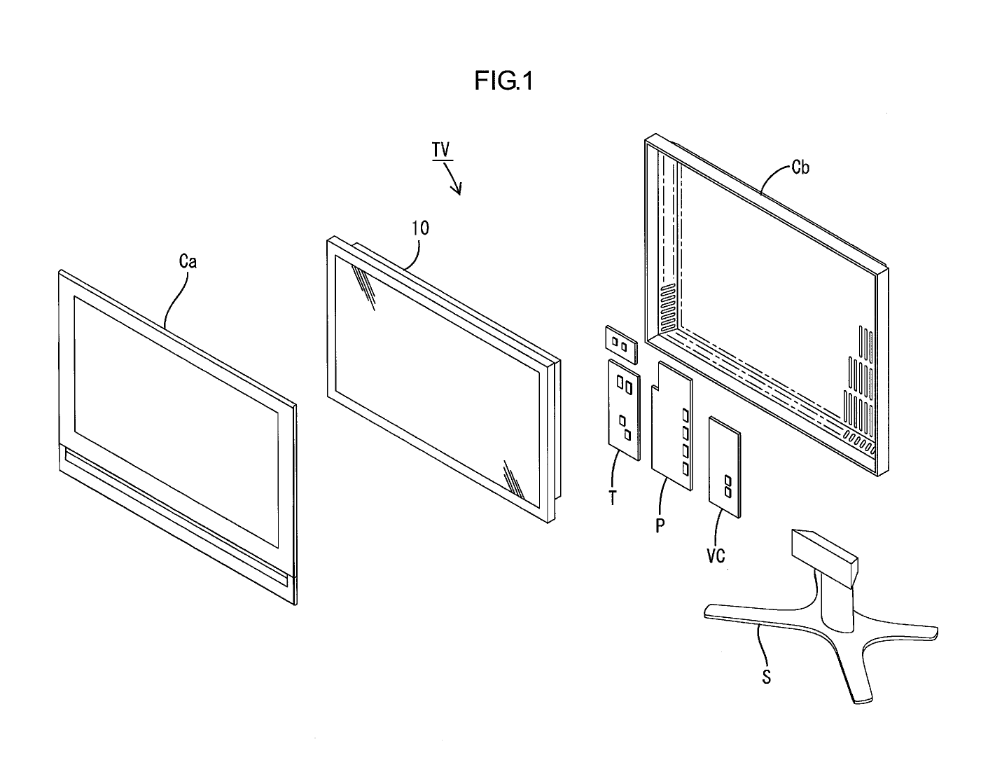

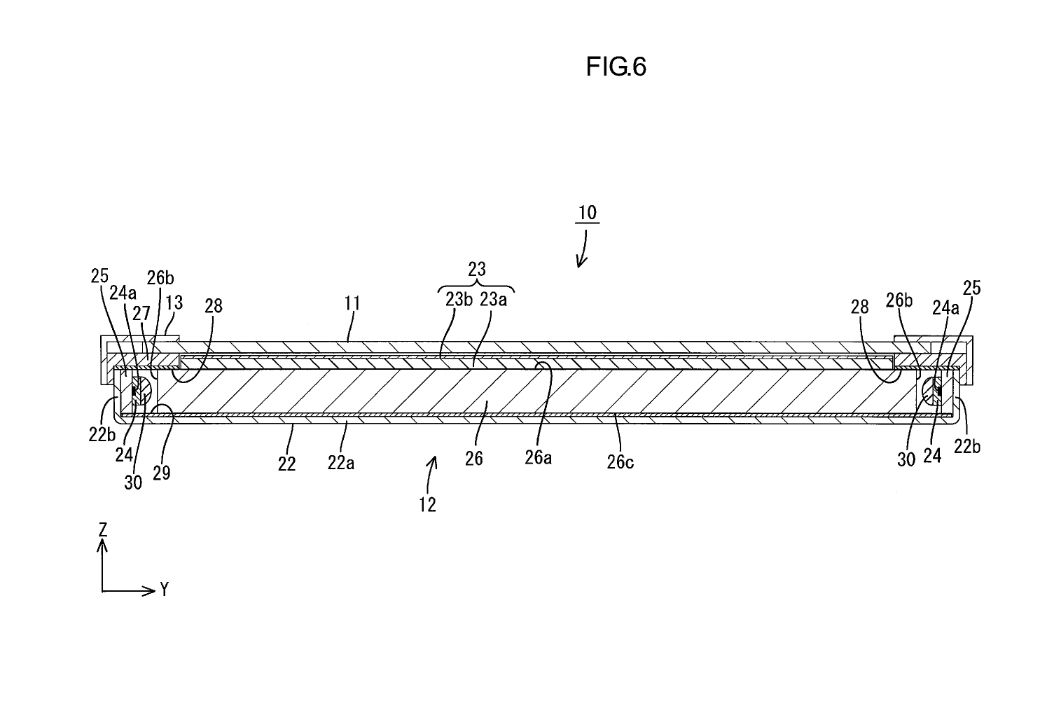

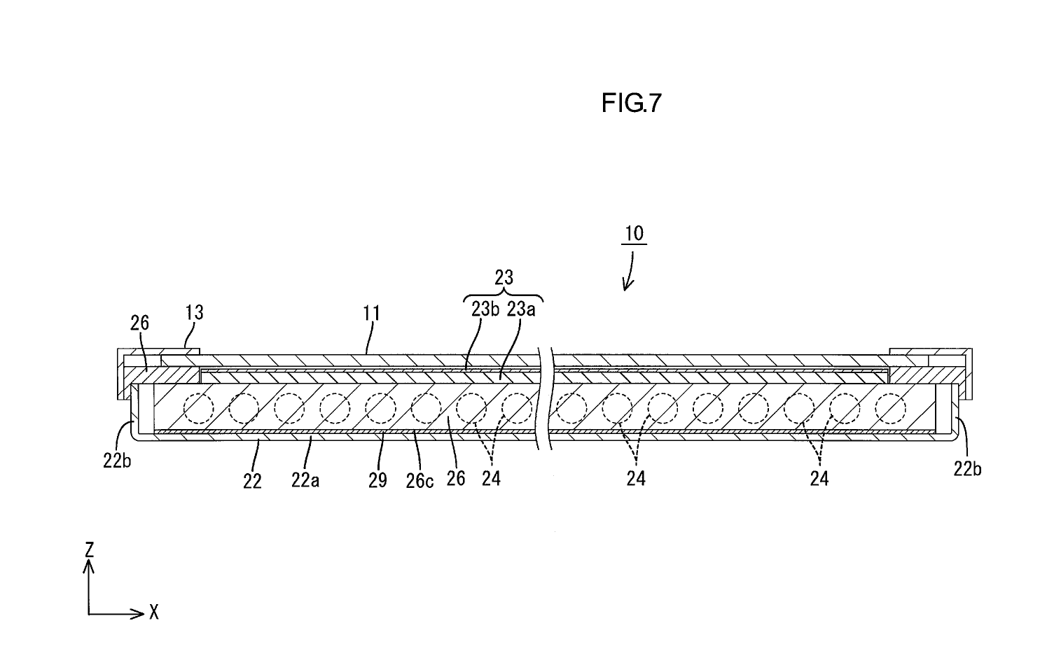

A first embodiment of the present invention will be explained with reference to FIGS. 1 to 9. In this embodiment, a liquid crystal display device 10 will be illustrated. X-axis, Y-axis and Z-axis are indicated in some drawings. The axes in each drawing correspond to the respective axes in other drawings. The upper side and the lower side in FIGS. 6 and 7 correspond to the front side and the rear side, respectively.

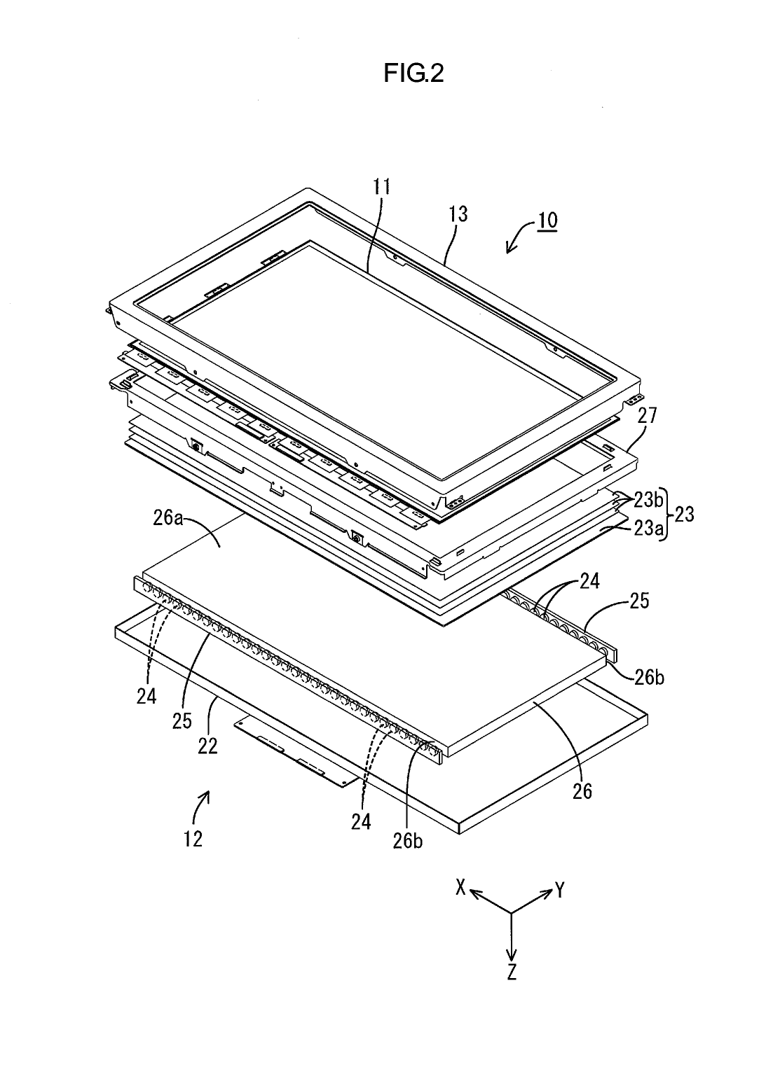

As illustrated in FIG. 1, a television receiver TV of this embodiment includes the liquid crystal display device 10, front and rear cabinets Ca, Cb that house the liquid crystal display device 10 therebetween, a power source P, a tuner (a receiver) T, an image converter circuit board VC, and a stand S. An overall shape of the liquid crystal display device (a display device) 10 is a landscape rectangular. The liquid crystal display device 10 is held with the long-side direction thereof substantially aligned with the horizontal direction (the X-axis direction) and the short-side direction thereof substantially aligned with the vertical direction (the Y-axis direction). As illustrated in FIG. 2, the liquid crystal display device 10 includes a liquid crystal panel 11 as a display panel, and a backlight unit (a lighting unit) 12 as an external light source. They are integrally held by a bezel 13 having a frame-like shape. The image converter circuit board VC is configured to convert television image signals from the tuner T into image signals for the liquid crystal display device 10.

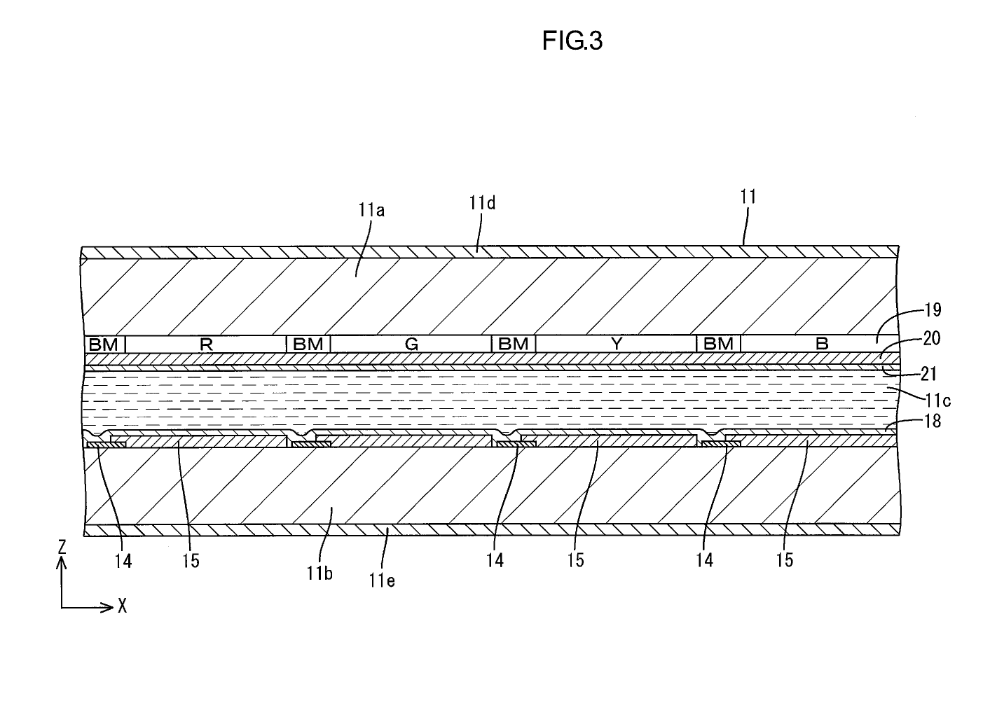

A configuration of the liquid crystal panel 11 included in the liquid crystal display device 10 will be explained in detail. The liquid crystal panel 11 has a landscape rectangular overall shape. As illustrated in FIG. 3, the liquid crystal panel 11 includes a pair of transparent glass substrates 11a, 11b (capable of light transmission) and a liquid crystal layer 11c. The liquid crystal layer 11c is provided between the substrates 11a and 11b. The liquid crystal layer 11c includes liquid crystals having optical characteristics that vary according to electric fields applied thereto. The substrates 11a and 11b are bonded together with a predetermined gap therebetween with sealant that is not illustrated. The long-side direction and the short-side direction of the liquid crystal panel 11 are aligned with the X-axis direction and the Y-axis direction, respectively.

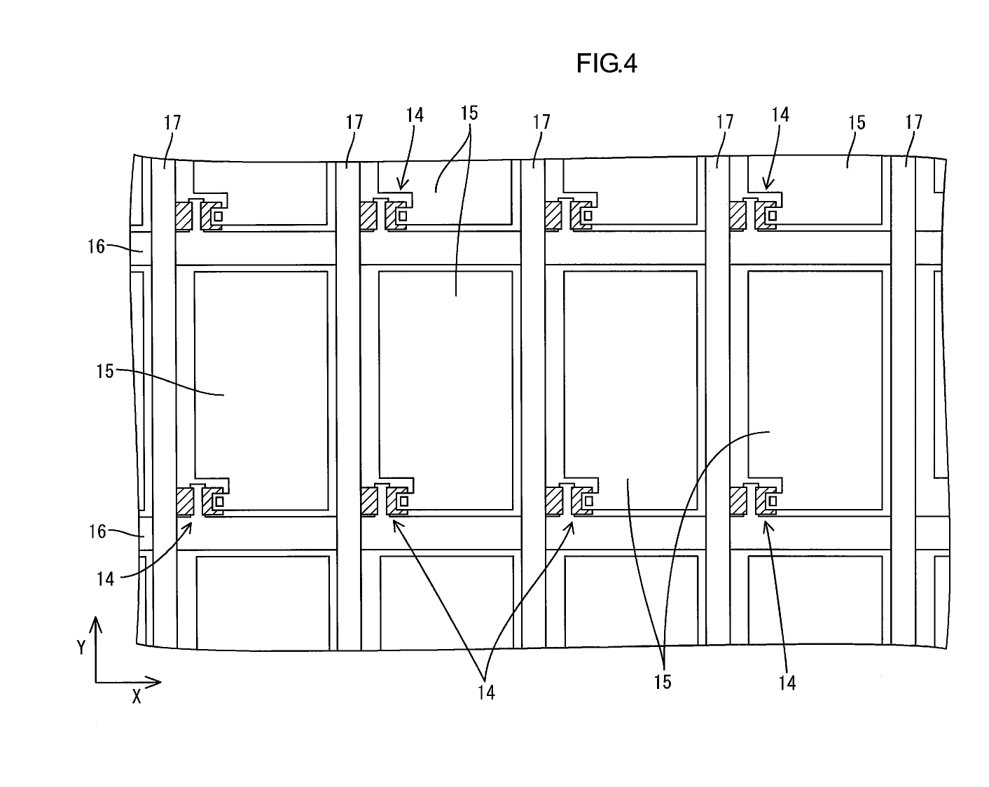

One of the substrates 11a, 11b on the front side is the CF substrate 11a and the other one of the substrates 11a, 11b on the rear side is the array board 11b. On the inner surface of the array board 11b, that is, a surface on the liquid crystal layer 11c side (opposite to the CF board 11a), a number of thin film transistors (TFTs) 14 and pixel electrodes 15 are arranged in a matrix as illustrated in FIG. 4. The TFTs 14 are switching elements. Furthermore, gate lines 16 and source lines 17 arranged perpendicular to each other and around the TFTs 14 and the pixel electrodes 15. Each pixel electrode 15 has a rectangular shape with the long-side direction and the short-side direction aligned with the Y-axis direction and the X-axis direction, respectively. The pixel electrode 15 is a transparent electrode made of indium tin oxide (ITO) or zinc oxide (ZnO). The gate lines 16 and the source lines 17 are connected to gate lines and source lines of the respective TFTs 14. The pixel electrodes 15 are connected to drain electrodes of the respective TFTs 14. An alignment film 18 is arranged on the liquid crystal layer 11c sides of the TFTs 14 and the pixel electrodes 15. The alignment film 18 is provided for alignment of liquid crystal molecules. In end portions of the array board 11b, terminals extended from the gate lines 16 and the source lines 17 are provided. A driver IC for driving the liquid crystal panel 11 is pressure bonded to the terminals via an anisotropic conductive film (ACF). The driver IC is not illustrated in the drawings. The driver IC is electrically connected to a display control circuit board via various wiring boards. The display control circuit board is not illustrated in the drawings. The display control circuit board is connected to the image converter board VC of the television receiver TV and configured to feed driving signals to the lines 16 and 17 according to output signals from the image converter circuit board VC via the driver IC.

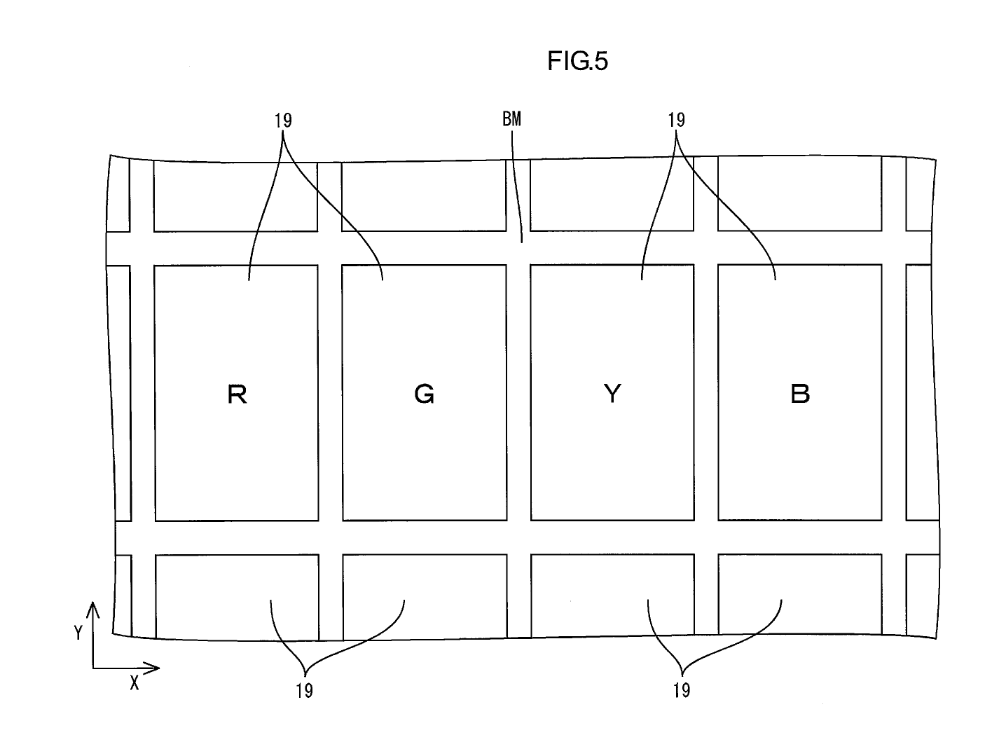

On the inner surface of the CF board 11a on the liquid crystal layer 11c side (opposite to the array board 11b), color filters 19 including a number of R, G, B and Y color portions arranged in a matrix according to the pixels on the array board 11b side, as illustrated in FIGS. 3 and 5. Each color filter 19 includes the Y color portion in yellow in addition to the R color portion in red, the G color portion in green, the B color portion in blue. Red, green and blue are three primary colors of light. The R color portion, the G color portion, the B color portion, and the Y color portion selectively pass the respective colors (or wavelengths) of light. The color filter 19 includes the R color portion in red, the G color portion in green, the Y color portion in yellow, and the B color portion in blue arranged in this sequence from the left side in FIG. 5 along the X-axis direction. Each of the R color portion, the G color portion, the B color portion, and the Y color portion has a rectangular shape with the long-side direction and the short-side direction thereof aligned with the X-axis direction and the Y-axis direction, respectively. Areas of the R color portion, the G color portion, the B color portion, and the Y color portion are all the same. A grid-like light blocking layer (a black matrix) BM is provided between the R color portion, the G color portion, the B color portion, and the Y color portion so that colors are less likely to be mixed. A counter electrode 20 and an alignment film 20 are overlaid with each other on the liquid crystal layer 11c side of the color filters 19 of the CF substrate 11a.

As described above, the liquid crystal display device 10 of this embodiment includes the liquid crystal panel 11 having the color filters 19. Each color filter 19 includes the color portions in four colors: the R color portion, the G color portion, the B color portion, and the Y color portion. The television receiver TV includes the designated image converter circuit board VC. The image converter circuit board VC converts television image signals from the tuner T to image signals relative to the respective colors of blue, green, red and yellow. The generated color image signals are inputted to the display control circuit board. The display control circuit board drives the TFTs 14 corresponding to the respective colors of the pixels of the liquid crystal panel 11 based on the image signals and controls the amounts of light passing through the R color portion, the G color portion, the B color portion, and the Y color portion, respectively.

As described above, each color filter 19 of this embodiment includes the Y color portion in addition to the R color portion, the G color portion, and the B color portion in three primary colors of light, respectively. Therefore, a color range of the display images displayed with the transmitted light is expanded and the images can be displayed with high color reproducibility. The light passed through the Y color portion in yellow has a wavelength close to a visible peak. Namely, people perceive the light as bright light even though the light is emitted with low energy. Even when the outputs of the light sources (the LEDs 24) in the backlight unit 12 are reduced, sufficient brightness still can be achieved. Therefore, the power consumption of the light sources can be reduced and the backlight unit 12 is provided with high environmental efficiency.

When the four-color-type liquid crystal panel 11 described above is used, an overall color of the display images tend to be yellowish. To solve this problem, the amounts of light passing through the R, G, G, Y color portions may be controlled by driving the TFTs 14 and the chromaticity of the display images may be corrected. An overall amount of transmitted light tends to decrease according to the correction of the chromaticity and thus the brightness may decrease. In view of such a problem, the inventor of this application has created a method for correcting the chromaticity of display images without a reduction in brightness by adjusting the chromaticity of light sources in the backlight unit 12. Specifically, the LEDs 24 are used as light sources and the chromaticity thereof are adjusted in this embodiment. Configurations of the backlight unit 12 including the LEDs 24 as light sources will be explained and then detailed configurations of the LEDs 24 and detailed adjustment procedures of the chromaticity will be explained.

As illustrated in FIG. 2, the backlight unit 12 includes a chassis 22 and an optical member set 23. The chassis 22 has a box-like shape and an on the light emitting side (on the liquid crystal panel 11 side). The optical member set 23 is arranged so as to cover the opening of the chassis 22. The optical member set 23 includes a diffuser plate (a light diffusing member) 23a and a plurality of optical sheets 23b arranged between the diffuser plate 23a and the liquid crystal panel 11. Light emitting diodes (LEDs) 24 are installed in the chassis 22 as light sources. Furthermore, LED boards 25 on which the LEDs 24 are mounted, a light guide member 26, and a frame 27 are arranged inside the chassis 22. The light guide member 26 is configured to guide light from the LEDs 24 to the optical member set 23 (or the liquid crystal panel 11). The frame 27 holds down the light guide member 26 from the front side. The backlight unit 12 is a so-called edge-light-type (or a side-light-type) in which the LED boards 25 having the LEDs 24 arranged at long-side edges and the light guide member 26 arranged in the middle area between the LED boards 25. Components of the backlight unit 12 will be explained in detail.

The chassis 22 is made of metal. As illustrated in FIGS. 6 and 7, the chassis 22 includes a bottom plate 22a and side plates 22b. The bottom plate 22a has a rectangular shape similar to the liquid crystal panel 11. Each side plate 22b rises from an outer edge of the corresponding side of the bottom plate 22a. The chassis 22 has a shallow-box-like overall shape with an opening on the front side. The long-side direction and the short-side direction are aligned with the X-axis direction (the horizontal direction) and the Y-axis direction (the vertical direction), respectively. The frame 27 and the bezel 13 are fixed to the side plates 22b with screws.

As illustrated in FIG. 23, the optical member set 23 has a landscape rectangular plan-view shape similar to the liquid crystal panel 11 and the chassis 22. The optical member set 23 is arranged on the front surface of the light guide member 26 (on the light exit side) between the liquid crystal panel 11 and the light guide member 26. The optical member set 23 includes the diffuser plate 23a and the optical sheets 23b. The diffuser plate 23a is arranged on the rear side (the light guide member 26 side, an opposite side from the light exit side). The optical sheets 23b are arranged on the front side (the liquid crystal panel 11 side, the light exit side). The diffuser plate 23a is constructed of a plate-like member in a specified thickness and made of substantially transparent synthetic resin with light-scattering particles dispersed therein. Each optical sheet 23b has a sheet-like shape with a thickness smaller than that of the diffuser plate 23a. Three sheets are overlaid with each other. Examples of the optical sheets 23b are a diffuser sheet, a lens sheet and a reflection-type polarizing sheet. Each optical sheet 23b can be selected from those sheets accordingly.

As illustrated in FIG. 2, the frame 27 has a frame-like shape extending along the periphery of the light guide member 26. The frame 27 holds down substantially entire edges of the light guide member 26 from the front side. The frame 27 is made of synthetic resin. The front surface of the frame 27 may be in black so as to have a light blocking capability. As illustrated in FIG. 6, first reflection sheets 28 are mounted to the backsides of the respective long-side portions of the frame 27, that is, surfaces opposed to the light guide member 26 and the LED boards 25 (or the LEDs 24). Each first reflection sheet 28 has a dimension extending for a substantially entire length of the long-side portion of the frame 27. The first reflection sheet 28 is directly in contact with the edge of the light guide member 26 on the LED 24 side. The first reflection sheet 28 collectively covers the edge of the light guide member 26 and the LED board 25 from the front side. The frame 27 receives the outer edges of the liquid crystal panel 11 from the rear side.

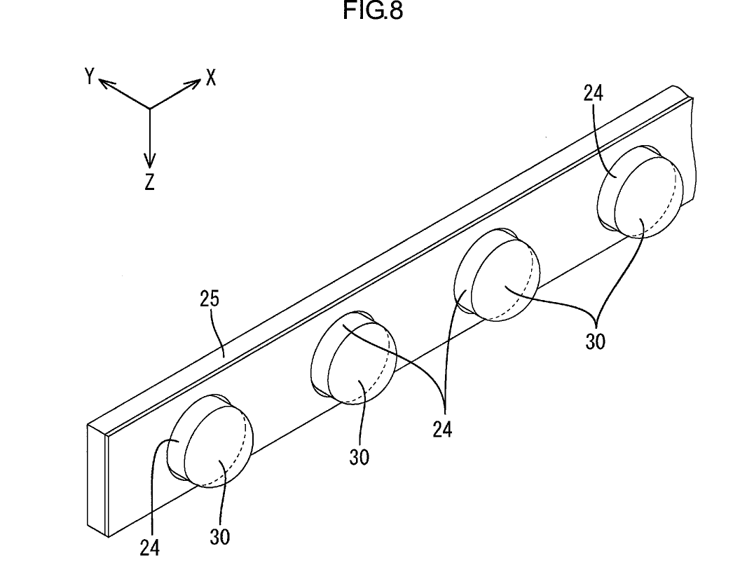

As illustrated in FIG. 2, each LED 24 is mounted on the LED board 25. A surface of the LED 24 opposite from amounting surface thereof to the LED board 25 is a light emitting surface, that is, the LED 24 is a top light type. As illustrated in FIGS. 6 and 8, a lens 30 is disposed on the light emitting surface of each LED 24 for diffusing and emitting light in a wide angle. The lens 30 is arranged between the LED 24 and the light entrance surface 26b of the light guide member 26 so as to project toward the light guide member 26. A light exit surface of the LED 24 is a spherical surface. The light exit surface of the lens 30 is curved along the light entrance surface 26b the light guide member 26 so as to form an arc-like shape in a cross-sectional view. A detailed configuration of each LED 24 will be explained later.

As illustrated in FIG. 2, each LED board 25 has an elongated plate-like shape extending along the long-side direction of the chassis 22 (the X-axis direction, the long-side direction of the light entrance surface 26b of the light guide member 26). The LED board 25 is arranged with the main board surface parallel to the X-Z plane, that is, perpendicular to board surfaces of the liquid crystal panel 11 and the light guide member 26 (or the optical member 23) and housed in the chassis 22. The LED boards 25 are provided in a pair and arranged at the long inner edges of the chassis 22, respectively. The LEDs 24 are surface-mounted on the main board surface of each LED board 25, which is an inner surface opposite the light guide member 26 (the opposite surface to the light guide member 26). A plurality of the LEDs 24 are arranged in line (i.e., linearly) on the mount surface of the LED board 25 along the long side of the LED board 25 (the X-axis direction). Namely, the LEDs 24 are arranged at the long sides of the backlight unit 12 along the longitudinal direction, respectively. The LED boards 25 in a pair are arranged so as to face each other and housed in the chassis 22. Therefore, the light emitting surfaces of the LEDs 24 on one of the LED boards 25 face the light emitting surfaces of the LEDs 24 on the other LED board 25. Light axes of the LEDs 24 are substantially aligned with the Y-axis direction.

The substrate of each LED board 25 is made of metal, for instance, aluminum-contained material similar to the chassis 22. On the surface of the substrate, metal-film wiring patterns (not illustrated) including copper foil wiring patterns are formed via an insulating film. A reflection layer (not illustrated) in white having high light reflectivity is formed on the outermost surface of the substrate of each LED board 25. With the wiring patterns, the LEDS 24 arranged on the LED board 25 are connected in series. A material used for the LED boards 25 may be an insulating material including ceramic.

Next, the light guide member 26 will be explained in detail. The light guide member 26 is made of synthetic resin that is nearly transparent (i.e., capable of light transmission at a high level) and has a refraction index higher than that of the air (e.g., acrylic). As illustrated in FIG. 2, the light guide member 26 has a rectangular plan-view shape similar to the liquid crystal panel 11 and the chassis 22 with the long sides and the short sides aligned with the X-axis direction and the Y-axis direction, respectively. The light guide member 26 is arranged below the liquid panel 11 and the optical member 23 inside the chassis 22 and between the LED boards 25 arranged at the long edges of the chassis 22 with respect to the Y-axis direction. An arrangement direction of the LEDs 24 (or the LED boards 25) and the light guide member 26 is along the Y-axis direction and an arrangement direction of the optical member set 23 (or the liquid crystal panel 11) and the light guide member 26 is along the Z-axis direction. The arrangement directions are perpendicular to each other. The light guide member 26 receives light from the LEDs 24 in the Y-axis direction, passes it therethrough, and directs it to the optical member 23 (in the Z-axis direction). The light guide member 26 is slightly larger than the optical member set 23 and the thus the peripheral edges thereof project from the peripheral edges of the optical member set 23. The peripheral edges of the light guide member 26 are held down by the frame 27 described earlier (see FIGS. 6 and 7).

The light guide member 26 has a plate-like shape extending along the bottom plate 22a of the chassis 22 and the board surface of the optical member set 23. The main board surfaces of the light guide member 26 are parallel to the X-Z plane. A surface of the main board surfaces of the light guide member 26 on the front side is a light exit surface 26a through which light exits toward the optical member set 23 and the liquid crystal panel 11. Long-side peripheral edge surfaces extending along the X-axis direction among peripheral edge surfaces adjacent to the main board surfaces of the light guide member 26 are arranged so as to face the LEDs 24 (the LED boards 25) with specified distances therefrom. The long-side peripheral edge surfaces are the light entrance surfaces 26b through which light from the LEDs 24 enters. The light entrance surfaces 26b are parallel to the X-Z plane and perpendicular to the light exit surface 26a. An arrangement direction of the LEDs 24 and the light entrance surfaces 26b is aligned with the Y-axis direction and parallel to the light exit surface 26a. A second reflection sheet 29 is arranged on an opposite surface 26c of the light guide member 26 opposite from the light exit surface 26a so as to cover an entire area of the opposite surface 26c. The second reflection sheet 29 is configured to reflect light toward the front side. The second reflection sheet 29 extends to areas overlapping the LED boards 25 (or the LEDs 24) in plan view. The second reflection sheet 29 is arranged such that the LED boards 25 (or the LEDs 24) are sandwiched between the first reflection sheet 28 on the front side and the second reflection sheet 29. With this configuration, rays of light from the LEDs 24 are repeatedly reflected by the light reflection sheets 28 and 29. Therefore, the rays of light efficiently directed to the light guide member 26 through the light entrance surfaces 26b. At least one of the light exit surface 26a and the opposite surface 26c of the light guide member 26 has a reflecting portion (not illustrated) configured to reflect light inside or a scattering portion (not illustrated) configured to scatter light inside. The reflecting portion or the scattering portion may be formed by patterning with a specified in-plane distribution. With this configuration, the light exiting from the light ext surface 26a is controlled to have an even in-plane distribution.

In this embodiment, the LEDs 24 are used as light sources in the backlight unit 12 as described above. The LEDs 24 are better with optical characteristics of the liquid crystal display panel 11 (including the color filters 19 with the R, G, B, Y color portions in four different colors) in adjustment of chromaticity for correction of chromaticity of display images than cold cathode tubes. Therefore, relatively high brightness can be achieved. In this embodiment, each LED 24 includes a blue LED chip 24a as a light emitting source. The blue LED chip 24a emits blue light. Moreover, the LED 24 includes the green phosphor and the red phosphor that emit light when excited by the blue light are used as phosphors. Detailed configurations of the LEDs 24 will be explained below.

Each LED 24 includes the blue LED chip 24a arranged on the substrate fixed to the LED board 25 and sealed with resin. Each blue LED chip 24a mounted on the substrate has alight emitting peak in a green range and a phosphor that has a main light emitting peak in a blue wavelength range from 430 nm to 500 nm. The blue LED chip 24a emits blue light with high chromatic purity. The resin sealing the LED chip contains the green phosphor and the red phosphor at specified percentages. The green phosphor emits green light excited by glue light emitted from the blue LED chip 24a. The red phosphor emits red light excited by glue light emitted from the blue LED chip 24a. With the blue light emitted from the blue LED chip 24a (a blue component of light), the green light emitted from the green phosphor (a green component of light), and the red light emitted from the red phosphor (a red component of light), the LED 24 emits light in specific color such as white and bluish white. When the green component of light emitted by the green phosphor and the red component of light emitted by the red phosphor are mixed, yellow light is produced. Namely, the light emitted by the LED 24 includes the blue component of light emitted by the blue LED chip 24a and a yellow component of light. The chromaticity of the LED 24 varies according to absolute values or relative values of contents of the green phosphor and the red phosphor. Therefore, the chromaticity of the LED 24 can be adjusted by adjusting the contents of the green phosphor and the red phosphor. In this embodiment, the green phosphor has a main light emitting peak in a green wavelength range from 500 nm to 570 nm, and the red phosphor has a main light emitting peak in a red wavelength range from 610 nm to 780 nm.

Next, the green phosphor and the red phosphor of each LED 24 will be explained in detail. A β-SiAlON, which is a SiAlON-based nitride, is suitable for the green phosphor. With this configuration, green light can be emitted with high efficiency in comparison to a configuration in which sulfide or oxide is used for the phosphor. Furthermore, very high chromatic purity of the green light, which is emitted light, can be achieved with this configuration. This configuration is significantly effective for adjusting the chromaticity of the LED 24. Specifically, the β-SiAlON contains europium (Eu) as an activator and expressed by Si_{6-z}Al_{z}O_{z}N_{8-z}:Eu or (Si,Al)₆(O,N)₈:Eu, where z is a solid solubility. A CaAlSiN, which is nitride, or a CaAlSiN-based phosphor is suitable for the red phosphor. With this configuration, red light can be emitted with high efficiency in comparison to a configuration in which sulfide or oxide is used for the phosphor. Specifically, the CaAlSiN contains europium (Eu) as an activator and expressed by CaAlSiN₃:Eu.

The green phosphor may be altered from the β-SiAlON described above. With a phosphor expressed by (Y, Gd)₃Al₅O₁₂:Ce, which is a YAG-based phosphor, light can be emitted with high efficiency. The following inorganic phosphor may be suitable for the green phosphor: (Ba,Mg)Al₁₀O₁₇:Eu,Mn, SrAl₂O₄:Eu, Ba_{1.5}Sr_{0.5}SiO₄:Eu, BaMgAl₁₀O₁₇:Eu,Mn, Ca₃(Sc,Mg)₂Si₃O₁₂:Ce, Lu₃Al₅O₁₂:Ce, CaSc₂O₄:Ce, ZnS:Cu,Al, (Zn,Cd)S:Cu,Al, Y₃Al₅O₁₂:Tb, Y₃(Al,Ga)₅O₁₂:Tb, Y₂SiO₅:Tb, Zn₂SiO₄:Mn, (Zn, Cd)S:Cu, ZnS:Cu, Gd₂O₂S:Tb, (Zn,Cd)S:Ag, Y₂O₂S:Tb, (Zn, Mn)₂SiO₄, BaAl₁₂O₁₉:Mn, (Ba,Sr,Mg)O.aAl₂O₃:Mn, LaPO₄:Ce,Tb, Zn₂SiO₄:Mn, CeMgAl₁₁O₁₉:Tb, BaMgAl₁₀O₁₇: Eu, Mn.

The red phosphor may be altered from the CaAlSiN. The following inorganic phosphor may be suitable for the red phosphor: (Sr,Ca)AlSiN₃:Eu, Y₂O₂S:Eu, Y₂O₃:Eu, Zn₃(PO₄)₂:Mn, (Y,Gd,Eu)BO₃, (Y,Gd,Eu)₂O₃, YVO₄:Eu, La₂O₂S:Eu,Sm.

The chromaticity of each LED 24 having the above configuration is adjusted as follows. The liquid crystal panel 11 according to this embodiment includes the color filters 19 having the R, G, B, Y color portions in four different colors. Therefore, display images tend to be yellowish. By adjusting the chromaticity of light emitted by the LED 24 through the light emitting surface such that the light becomes bluish (or bluish white), which is a complementary color of yellow, the tinges of the display images can be corrected (i.e., the color is corrected to white). To adjust the chromaticity of the LED 24, the contents of the green phosphor and the red phosphor in the resin that seals the blue LED chip 24a are adjusted as appropriate. The β-SiAlON or the YAG-based phosphor expressed by (Y,Gd)₃Al₅O₁₂:Ce may be preferable for the green phosphor and the CaAlSiN may be preferable for the red phosphor. To confirm the advantage of the above configuration achieved by combining the LEDs 24 with adjusted chromaticity and including the blue LED chips 24a, the green phosphor, and the red phosphor to the liquid crystal panel 11 including the color filters 19 having the R, G, B, Y color sections in four different colors, the following experiments are performed.

### COMPARATIVE EXPERIMENTS

Experiments regarding chromaticity and brightness are performed to compare example devices with the liquid crystal panel 11 according to the above embodiment having the R, G, B, Y color sections and the LEDs 24 with adjusted chromaticity. The results are present in table 1. In table 1, the liquid crystal panel 11 is indicated as “Four-color panel” and the LEDs 24 are indicated as “Adjusted LED.” In example 1 of the comparative experiments, a three-color-type liquid crystal panel (“3-color panel” in table 1) including R, G, B color portions in three primary colors of light and LEDs configured to emit white light (“White LED” in table 1) are used. In example 2, a four-color-type liquid crystal panel including R, G, B, Y color portions in four colors and LEDs configured to emit white light without chromaticity adjustment (“Un-adjusted LED” in table 1). In example 3, a three-color-type liquid crystal panel including R, G, B color portions in three primary colors of light and cold cathode tubes configured to emit white light (“White CCFL” in table 1) are used. In example 4, a four-color-type liquid crystal panel including R, G, B, Y color portions in four colors and cold cathode tubes without chromaticity adjustment (“Un-adjusted CCFL” in table 1) are used. In example 5, a four-color-type liquid crystal panel including R, G, B, Y color portions in four colors and cold cathode tubes with chromaticity adjustment (“Adjusted CCFL” in table 1) are used. Measurements of the chromaticity of the light sources, the chromaticity of light exiting from the liquid crystal panel (or a display image) and the brightness of the light exiting from the liquid crystal panel (or a display image) in the examples and the embodiment are present in table 1.

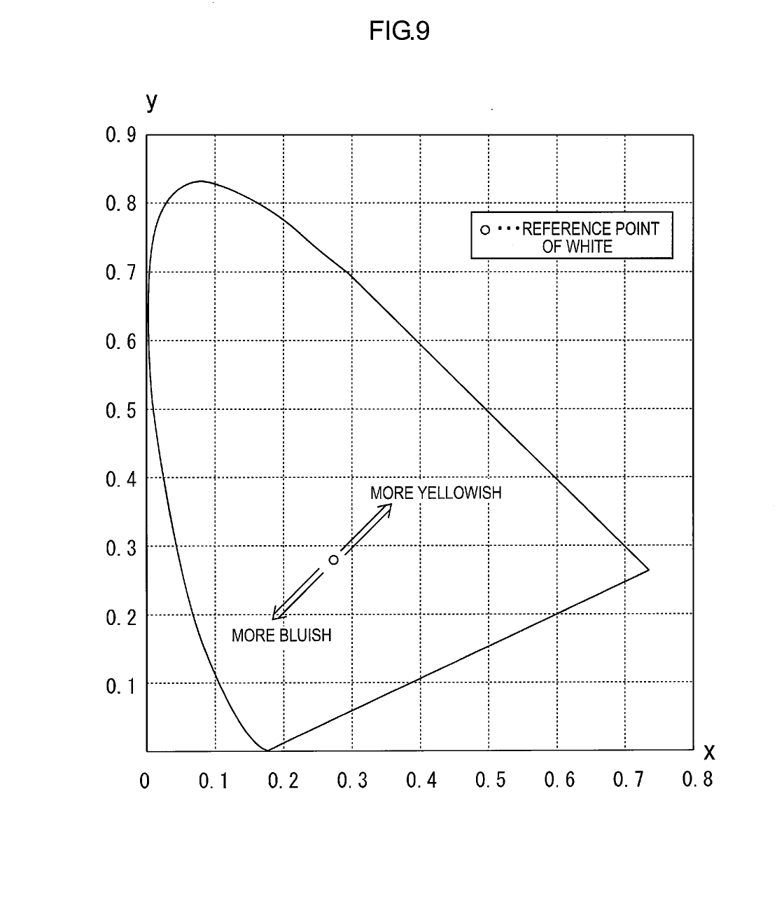

Colors are expressed by chromaticity coordinates (x, y) in the color space chromaticity diagram created by the International Commission on Illustration (CIE) in 1931 illustrated in FIG. 9 and provided in table 1. Brightness is expressed with reference to the brightness in example 1 and 3, which is 100% (a reference value). As illustrated in FIG. 9, the chromaticity coordinates (0.272, 0.277) indicate a reference point for white in the experiments. The color becomes more bluish as values x and y decrease and more yellowish as x and y increase.

TABLE 1

| | | Ex. 1 | Ex. 2 | Ex. 3 | Ex. 4 | Ex. 5 | Embodiment |
|---|---|---|---|---|---|---|---|
| | | 3-color panel | 4-color panel | 3-color panel | 4-color panel | 4-color panel | 4-color panel |
| | | white | Unadjusted | White | Unadjusted | Adjusted | Adjusted |
| | | LED | LED | CCFL | CCFL | CCFL | LED |
| Chromaticity | x | 0.2677 | 0.2677 | 0.2629 | 0.2629 | 0.22 | 0.2185 |
| of light source | y | 0.2331 | 0.2331 | 0.2354 | 0.2354 | 0.1576 | 0.1607 |
| Chromaticity | x | 0.272 | 0.3314 | 0.2723 | 0.3213 | 0.2717 | 0.272 |
| of light exiting | y | 0.277 | 0.3546 | 0.2767 | 0.3634 | 0.2773 | 0.277 |
| from LC panel | | | | | | | |

| | | | | | | |
|---|---|---|---|---|---|---|
| Brightness of light | 100% | 144.7% | 100% | 140.0% | 112.1% | 116.1% |
| exiting from LC | | | | | | |
| panel | | | | | | |

Comparisons are performed between results related to examples 1 and 2 and between results related to examples 3 and 4. When the color filter is altered from three-color filters to four-color filters without adjustment of the chromaticity of the light sources, the brightness of light exiting from the liquid crystal panel increases as illustrated in table 1 and FIG. 9. However, the chromaticity of the light exiting from the liquid crystal panel becomes yellowish. A possible cause of the increase in brightness according to the alteration of the color filters from the three-color filters to the four-color filters is that light passed through the Y color portions in yellow have a wavelength close to the visible peak. Comparisons are also performed between results related to example 2 and the embodiment and between results related to examples 4 and 5. By adjusting the chromaticity of the light sources such that the exiting light becomes bluish that is a complementary color of yellow, the brightness of the light exiting from the liquid crystal panel decreases. However, the chromaticity of the light exiting from the liquid crystal panel is corrected to substantially white. In comparison of the results between example 5 and the embodiment, the brightness of the light exiting from the liquid crystal panel in the embodiment is relatively higher than that in example 5. Namely, a reduction in brightness according to the adjustment of the chromaticity of light sources is suppressed. The embodiment includes the LEDs 24 as light sources and the blue LED chips 24a as light emitting sources. Therefore, blue light can be emitted with significantly high efficiency and thus the reduction in brightness may be less likely to occur even when the light sources are adjusted so that the exiting light becomes bluish. In the embodiment, the p-SiAlON or the YAG-based phosphor expressed by (Y,Gd)₃AL₅O₁₂:Ce is used for the green phosphor exited by the blue light emitted by the blue LED chips 24a. Furthermore, the CaAlSiN is used for the red phosphor. High light emitting efficiency of these phosphors may contribute to suppression of the reduction in brightness.

As described above, the liquid crystal display device 10 according to this embodiment includes the liquid crystal panel 11 and the backlight unit 12. The liquid crystal panel 11 is a display panel including a pair of the substrates 11a and 11b, and the liquid crystal layer 11c between the substrates 11a and 11b. The liquid crystal layer 11c includes substances having the optical characteristics that vary according to the application of the electric field. The backlight unit 12 is a lighting unit that emits light toward the liquid crystal panel 11. The CF substrate 11a of the substrates 11a and 11b of the liquid crystal panel 11 includes the color filters 19 having the R, G, B, Y color portions in red, green, blue and yellow, respectively. The backlight unit 12 includes the LEDs 24 as light sources.

One of the substrates 11a and 11b of the liquid crystal panel 11 includes the color filters 19 having the yellow color portions in yellow in addition to the R, G, B color portions in red, green, and blue, respectively, where red, green, and blue are three primary colors of light. With this configuration, the color reproduction range, colors in which are perceivable to human eyes, can be expanded, that is, the color gamut can be expanded. Furthermore, reproducibility of colors of objects in nature can be enhanced and thus display quality can be improved. Light exiting from the Y color portions in yellow among the R, G, B, Y color portions has a wavelength close to the visible peak. Namely, people perceive the light as bright light even though the light is emitted with low energy. Even when the outputs of the light sources are reduced, sufficient brightness still can be achieved. Therefore, the power consumption of the light sources can be reduced and the backlight unit 12 is provided with high environmental efficiency. Because the high brightness can be achieved as described above, clear contrast can be achieved. Therefore, the display quality can be further improved.

When the Y color portions in yellow are included in the color filters 19, the overall color of light exiting from the liquid crystal panel 11, that is, the overall color of the display images tend to be yellowish. To solve this problem, the amounts of light passing through the R, G, G, Y color portions may be controlled and the chromaticity of the display images may be corrected. An overall amount of transmitted light tends to decrease according to the correction of the chromaticity and thus the brightness may decrease. In view of such a problem, the inventor of this application has created a method for correcting the chromaticity of display images without a reduction in brightness by adjusting the chromaticity of light sources in the backlight unit 12. The LEDs 24 are used as light sources. The LEDs 24 are better with optical characteristics of the liquid crystal display panel 11 in adjustment of chromaticity for correction of chromaticity of display images than cold cathode tubes. Therefore, relatively high brightness can be achieved and thus the chromaticity of display images can be corrected without a reduction in brightness.

Each LED 24 includes the blue LED chip 24a as a light emitting source. The blue LED chip 24a emits blue light. Moreover, the LED 24 includes the green and the red phosphors that emit light when excited by the blue light are used as phosphors. The chromaticity of the LED 24 can be precisely adjusted by altering kinds and contents of the phosphors in the LED 24. Namely, the LED 24 can be configured more properly for the liquid crystal panel 11 having the Y color portions in yellow.

Each LED element includes the blue LED chip 24a that emits blue light. The phosphors are green and red phosphors that emit green light and red light, respectively, when excited by the blue light. Each LED 24 emits light in specified color using the blue light emitted by the blue LED chip 24a, the green light emitted by the green phosphor when excited by the blue light, and the red light emitted by the red phosphor when excited by the blue light. To correct the chromaticity of display images on the liquid crystal panel 11 having the Y color portions in yellow in addition to the color portions in three primary colors of light, the color of light from the light sources may be adjusted to be bluish color that is a complementary color of yellow. In this embodiment, each LED 24 includes the blue LED chip 24a as a light source. Therefore, the blue light can be emitted with significantly high efficiency. In the adjustment of color of light from the LED 24 to bluish color, the brightness is less likely to decrease and the brightness is maintained at a high level.

The green phosphor is the SiAlON-based phosphor. The SiAlON-based phosphor, which is nitride, is used for the green phosphor and thus green light can be emitted with high efficiency in comparison to a configuration in which sulfide or oxide is used for the phosphor. Furthermore, the light emitted by the SiAlON-based phosphor has higher chromatic purity in comparison to the YAG-based phosphor. Therefore, the chromaticity of light emitted by the LEDs 24 can be more easily adjusted.

The green phosphor may be p-SiAlON. With this configuration, green light can be emitted with high efficiency. The light emitted by the β-SiAlON has especially high chromatic purity and thus the chromaticity of light emitted by the LEDs 24 can be further easily adjusted.

The red phosphor is CaAlSiN-based phosphor. The CaAlSiN-based phosphor, which is nitride, is used for the red phosphor and thus red light can be emitted with high efficiency in comparison to a configuration in which sulfide or oxide is used for the phosphor.

The CaAlSiN expressed by CaAlSiN₃:Eu is used for the red phosphor. With this configuration, red light can be emitted with high efficiency.

The green phosphor may be YAG-based phosphor. YAG-based phosphor containing yttrium or aluminum can be used for the green phosphor. With this configuration, green light can be emitted with high efficiency.

The backlight unit 12 includes the light guide member 26 made of synthetic resin and arranged such that the LEDs 24 are opposed to the edges of the light guide member 26. Light from the LEDs 24 passed through the light guide member 26 is directed to the liquid crystal panel 11. The light guide member 26 made of synthetic resin generally has high transparency. However, the light guide member 26 may be slightly yellowish. If so, light emitted by the LEDs 24 passed through the light guide member 26 may become slightly yellowish. In such a case, the chromaticity of the LEDs 24 may be adjusted according to the color of the light guide member 26 in yellowish color in addition to the adjustment by the liquid crystal panel 11 having the Y color portions in yellow. As a result, the chromaticity of display images can be properly corrected without a reduction in brightness.

The light guide member 26 has the longitudinal light entrance surfaces 26b at the ends close to the LEDs 24. The lenses 30 for diffusing light are arranged so as to cover the light emitting surfaces of the LEDs 24. Each lens 30 is arranged opposite the light entrance surface 26b of the light guide member 26 and curved along the light entrance surface 26b of the light guide member 26 so as to project toward the light guide member 26. With this configuration, light emitted from the LED 24 is spread by the lens 30 in the longitudinal direction of the light entrance surface 26b. Therefore, a dark spot is less likely to be formed on the light entrance surface 26b of the light guide member 26. Even if a distance between the LED 24 and the light guide member 26 and the number of the LEDs 24 are small, light with uniform brightness enters the light guide member 26 through the entire light entrance surface 26b.

The backlight unit 12 includes the reflection sheets 28 and 29 arranged along the longitudinal direction of the light entrance surfaces 26b between the LEDs 24 and the light guide member 26. Rays of light scattered by the lenses 30 and travel outside the light guide member 26 are reflected by the reflection sheets 28 and 29, and directed to the light guide member 26. With this configuration, the efficiency in directing the light emitted by the LEDs 24 to the light guide member 26 can be improved.

The liquid crystal display panel 11 including the liquid crystal layer 11c is used as a display panel. The liquid crystal layer 11c includes substances that vary the optical characteristics according to the application of electric field. This configuration can be used in various applications including television sets and personal computer displays. This configuration is especially preferable for large-screen applications.

The television receiver TV of this embodiment includes the liquid crystal display device 10 and the tuner T that is a television signal receiver. The television receiver TV includes the liquid crystal display device 10 configured to display television images according to television signals. The liquid crystal display device 10 can properly correct the chromaticity of display images while it achieves high brightness. Therefore, the television images can be provided with high display quality.

The television receiver TV includes the image converter circuit VC configured to convert the television image signals output by the tuner T into blue, green, red, and yellow image signals. With this configuration, the television signals are converted into the color image signals corresponding to the R, G, B, Y color portions in red, green, blue and yellow, respectively, by the image converter circuit VC. Therefore, the television images are provided with high display quality.

### Second Embodiment

Next, a second embodiment of the present invention will be explained. In this embodiment, a yellow phosphor is used for the phosphor of the LEDs instead of the green phosphor. The same configurations, operations, and effects as those in the first embodiment will not be explained.

Each LED of this embodiment includes a blue LED chip and a red phosphor similar to the first embodiment, and a yellow phosphor. The yellow phosphor emits yellow light excited by blue light emitted by the blue LED chip. In this embodiment, the yellow phosphor has a main light emitting peak in a yellow wavelength range from 570 nm to 600 nm. α-SiAlON may be preferable for the yellow phosphor. The α-SiAlON is SiAlON-based nitride. With this configuration, yellow light can be emitted with high efficiency in comparison to a configuration in which sulfide or oxide is used for the phosphor. Specifically, the α-SiAlON contains europium (Eu) as an activator and expressed by Mx(Si,Al)₁₂(O,N)₁₆:Eu, where M is metal ion and x is a solid solubility. When calcium is used for a metal ion, the yellow phosphor is expressed by Ca(Si,Al)₁₂(O,N)₁₆:Eu. A phosphor preferable for the yellow phosphor other than the α-SiAlON may be BOSE, which is a BOSE-based phosphor. The BOSE contains europium (Eu) as an activator and expressed by (Ba.Sr)₂SiO₄:Eu. Other kinds of phosphors than the α-SiAlON and the BOSE can be used for the yellow phosphor. YAG-based phosphors expressed by (Y,Gd)₃Al₃O₁₂:Ce may be preferable because high light-emitting efficiency can be achieved. The main light emitting peak of the phosphors expressed by (Y,Gd)₃A₁₃O₁₂:Ce is substantially flat extending from the green wavelength range to the yellow wavelength range. Namely, the phosphor may be considered as a green phosphor or a yellow phosphor. A phosphor expressed by Tb₃A₁₅O₁₂:Ce can be used for the yellow phosphor. With the configuration using the yellow phosphor instead of the green phosphor, the same effects as the first embodiment can be achieved.

As described above, the yellow phosphor of this embodiment is the α-SiAlON. Whit this configuration, yellow light can be emitted with high efficiency.

The yellow phosphor may be the BOSE-based phosphor. The BOSE-based phosphor containing barium and strontium can be used for the yellow phosphor.

The yellow phosphor may be the YAG-based phosphor. The YAG-based phosphors containing yttrium and aluminum can be used for the yellow phosphor. With this configuration, light can be emitted with high efficiency.

### Third Embodiment

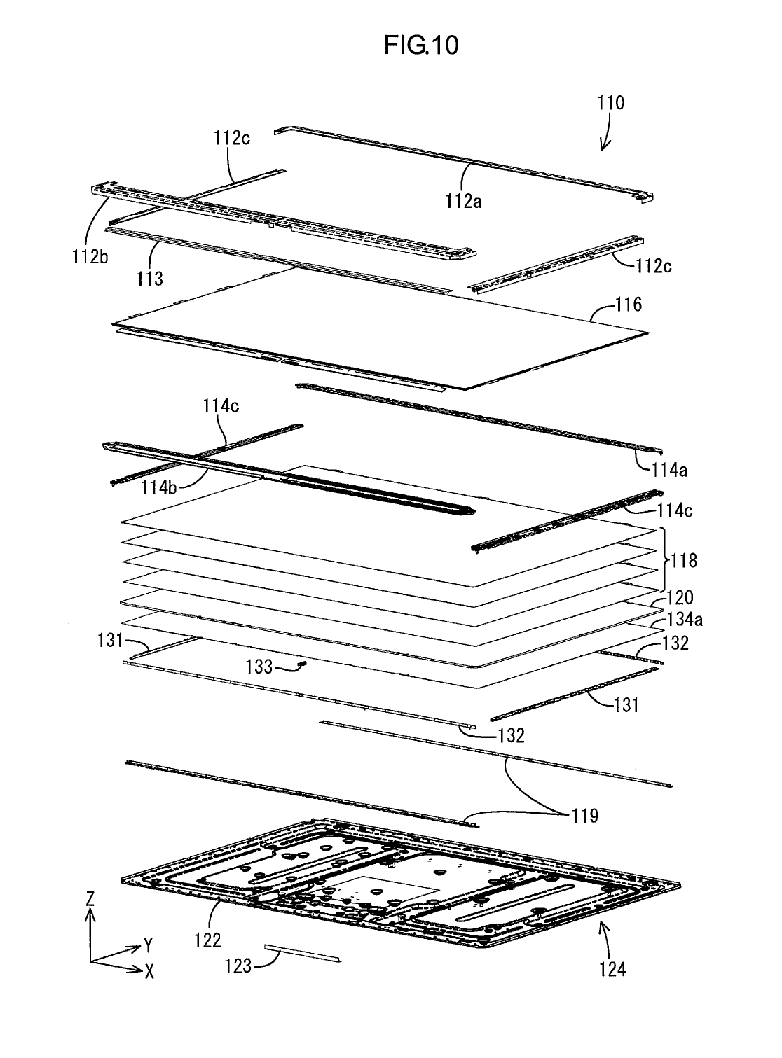

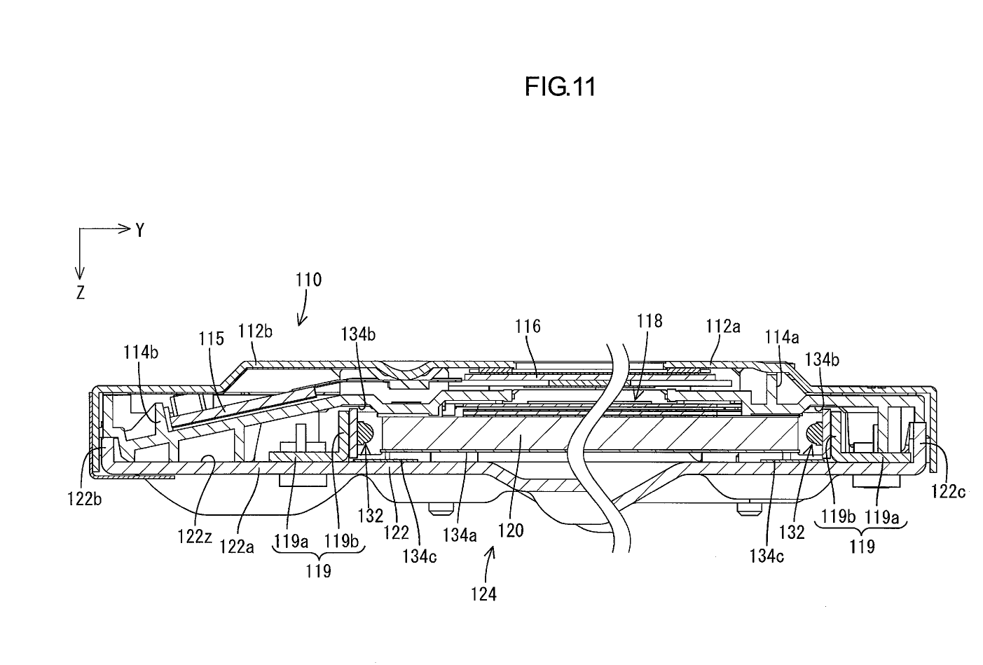

A third embodiment of the present invention will be explained with reference to FIGS. 10 and 11. In this embodiment, a liquid crystal display device 110 including different components from the first embodiment is used. The same configurations, operations, and effects as those in the first embodiment will not be explained.

FIG. 10 is an exploded perspective view of the liquid crystal display device 110 of this embodiment. In FIG. 10, the upper side and the lower side corresponding to the front side and the rear side of the liquid crystal display device 110, respectively. As illustrated in FIG. 10, the liquid crystal display device 110 has a landscape rectangular overall shape. The liquid crystal display device 110 includes a liquid crystal panel 116 that is a display panel and a backlight unit 124 that is an external light source. The liquid crystal panel 116 and the backlight unit 124 are integrally held by a top bezel 112a, a bottom bezel 112b, and side bezels 112c (hereinafter referred to as bezels 112a-112c). The configuration of the liquid crystal panel 116 is similar to that of the first embodiment and will not be explained.

The backlight unit 124 will be explained. As illustrated in FIG. 10, the backlight unit 124 includes a backlight chassis (a holding member, a support member) 122, an optical member set 118, a top frame (a holding member) 114a, a bottom frame (a holding member) 114b, side frames (holding members) 114c (hereinafter referred to as frames 114a-114c), and a reflection sheet 134a. The liquid crystal panel 116 is held sandwiched between the bezels 112a-112c and the frames 114a-114c. Numeral 113 indicates an insulation sheet for insulating a display control circuit board 115 (see FIG. 11) for driving the liquid crystal panel 116. The backlight chassis 122 has a box-like shape with an opening on the front side (the light exit side, the liquid crystal panel 116 side) and with a bottom surface. The optical member set 118 is arranged on the front side of alight guide plate 120. The reflection sheet 234a is arranged on the backside of the light guide plate 120. The backlight chassis 122 houses a pair of cable holders 131, a pair of heatsinks (mounting heatsinks), a pair of LED units 132, and the light guide plate 120. The LED units 132, the light guide plate 120, and the reflection sheet 134a are supported by rubber bushings 133. A power supply circuit board (not illustrated) and a protection cover 123 are mounted to the backside of the backlight chassis 122. The power supply circuit board is configured to supply power to the LED units 132. The cable holders 131 are arranged along the short sides of the backlight chassis 122. The cable holders 131 hold the wires for electrically connecting the LED units 132 to the power supply circuit board.

FIG. 11 illustrates a horizontal cross-sectional view of the backlight unit 124. As illustrated in FIG. 11, the backlight chassis 122 includes a bottom plate 122a with a bottom surface 122z and side plates 122b, 122c slightly rise from the outer edges of the bottom plate 122a. The backlight chassis 122 holds at least the LED units 132 and the light guide member 120. Each heatsink 119 includes a bottom plate (a second plate) 119a and a side plate (a first plate) 119b that rises from one of long edges of the bottom plate 119a. Namely, the heatsink 119 has an L-shape in horizontal cross-sectional view. The heatsinks 119 are arranged along the respective long sides of the backlight chassis 122. The bottom plates 119a of the heatsinks 119 are fixed to the bottom plate 122a of the backlight chassis 122. The LED units 132 extend along the respective long sides of the backlight chassis 122. The LED units 132 are arranged with light emitting sides thereof face each other and fixed to the side plates 119b of the respective heatsinks 119. The LED units 132 are held by the bottom plates 122a of the backlight chassis 122 via the heatsinks 119. The heatsinks 119 release heat generated by the LED units 132 to the outside of the backlight unit 124 via the bottom plate 122a of the backlight chassis 122.

As illustrated in FIG. 11, the light guide plate 120 is arranged between the LED units 132. The LED units 132, the light guide plate 120, and the optical member 118 are held by the frames (a first holding member) 114a-114c and the backlight chassis (a second holding member) 122. The light guide plate 120 and the optical member set 118 are fixed to the frames 114a-114c and the backlight chassis 122. The configurations of the LED units 132, the light guide plate 120, and the optical member set 118 are similar to those of the first embodiment and will not be explained.

As illustrated in FIG. 11, a drive circuit board 115 is arranged on the front side of the bottom frame 11b. The drive circuit board 115 is electrically connected to the display panel 116 and configured to send image data and various control signals necessary for displaying images to the liquid crystal panel 116. The first reflection sheet 134b is arranged in an area of the front surface of the top frame 114a exposed to the LED unit 132 along the long side of the light guide member 120. The other first reflection sheet 134b is arranged in an area of the front surface of the bottom frame 114b opposite the LED unit 132 along the long side of the light guide plate 120.

### Fourth Embodiment

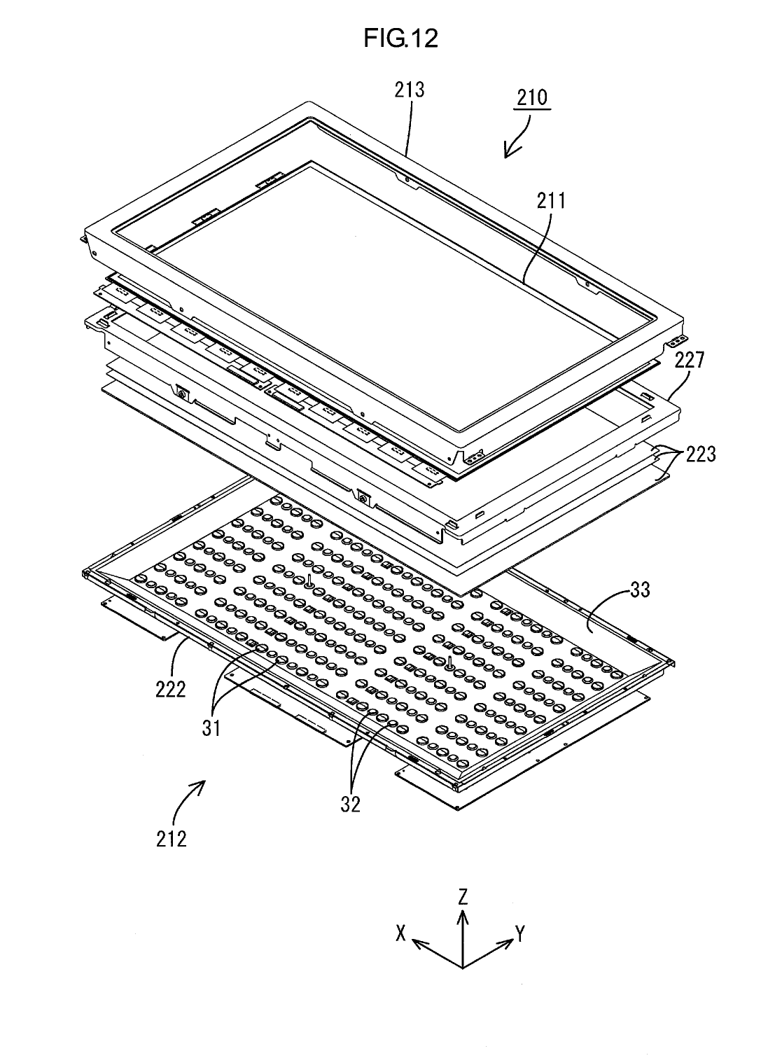

A fourth embodiment of the present invention will be explained with reference to FIGS. 12 to 18. In this embodiment, a direct backlight 212 is used. The same configurations, operations, and effects as those in the first embodiment will not be explained.

As illustrated in FIG. 12, a liquid crystal display device 210 includes a liquid crystal panel 211 and the direct backlight unit 212 integrally held by bezels 213. The configuration of the liquid crystal panel 211 is similar to that of the first embodiment and will not be explained. The direct backlight unit 212 will be explained.

As illustrated in FIG. 12, the backlight unit 212 includes a chassis 222, a optical member set 223, and a frame 227. The chassis 222 has a box-like shape with an opening on the light exit side (the liquid crystal panel 11 side). The optical member set 223 is arranged so as to cover the opening of the chassis 222. The frame 227 is arranged along outer edges of the chassis 222. The outer edges of the optical member set 223 are sandwiched between the chassis 222 and the frame 227. LEDs 224, LED boards 225, and diffuser lenses 31 are arranged inside the chassis 222. The LEDs 224 are arranged below the optical member 222 (or the liquid crystal panel 211) so as to face the optical member 223. The LEDs 224 are arranged on the LED boards 225. The diffuser lenses 31 are mounted to the LED boards 225 in locations corresponding to the LEDs 224. Furthermore, retention members 32 and a reflection sheet set 33 are arranged inside the chassis 222. The retention members 32 support the LED boards 225 with the chassis 222. The reflection sheet set 33 reflects light inside the chassis 222 toward the optical member set 223. Because the backlight 212 of this embodiment is a direct backlight, the light guide member 26 included in the backlight unit 12 of the first embodiment is not required. The configuration of the optical member set 223 is similar to that of the first embodiment and will not be explained. The configuration of the frame 227 is similar to that of the first embodiment except for the first reflection sheet 28 and thus will not be explained. Next, components of the backlight unit 212 will be explained in detail.

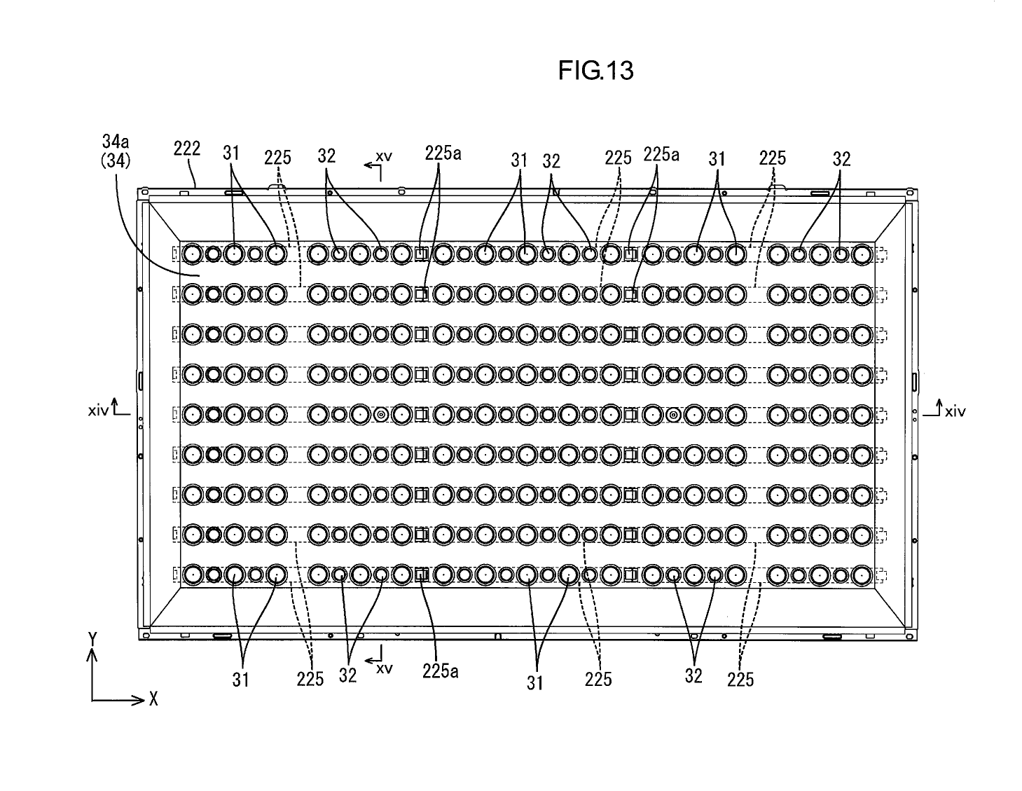

The chassis 222 is made of metal. As illustrated in FIGS. 13 to 15, the chassis 222 has a shallow box-like overall shape (a shallow tray-like overall shape) with an opening on the front side. The chassis 222 includes a bottom plate 222a, side plates 222b, and receiving plates 222c. The bottom plate 222a has a landscape rectangular shape similar to the liquid crystal panel 211. The side plates 222b rise from the outer side edges of the bottom plate 222a (a pair of long sides and a pair of short sides) toward the front side (the light exit side). The receiving plates 222c project outward from the distal ends of the respective side plates 222b. The long-side direction and the short-side direction of the chassis 222 are aligned with the X-axis direction (the horizontal direction) and the Y-axis direction (the vertical direction), respectively. The frame 227 and the optical member set 223, which will be explained next, are placed on the receiving plates 222c of the chassis 222. The frame 227 is fixed to the receiving plates 222c with screws. The bottom plate 222a of the chassis 222 has mounting holes 222d for mounting the retention members 32. The mounting holes 222d are formed at different locations in the bottom plate 222a corresponding to mounting positions of the retention members 32.

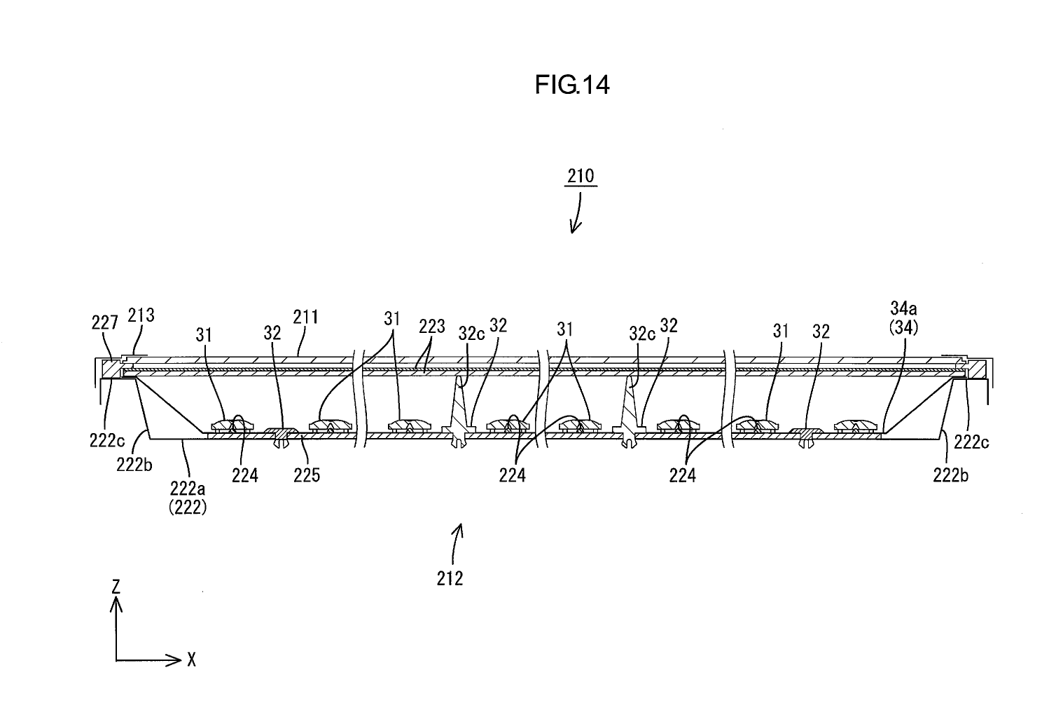

Next, the LED boards 225 on which the LEDs 224 are mounted will be explained. The configuration of the LEDs 224 is similar to that of the first embodiment described earlier and thus will not be explained. As illustrated in FIGS. 13 and 14, the each LED board 225 includes a substrate having a landscape rectangular shape in plan view. Each LED board 225 is arranged inside the chassis 222 with the long-side direction and the short-side direction thereof aligned with the X-axis direction and the Y-axis direction, respectively, so as to extend along the bottom plate 222a. The LEDs 224 are surface-mounted on one of the board surfaces of each LED board 225 on the front side (facing the optical member set 223). The light emitting surface of each LED 224 is opposed to the optical member set 223 (or the liquid crystal panel 211). A light axis LA of the LED 224 is aligned with the Z-axis direction, that is, a direction perpendicular to the display surface of the liquid crystal panel 211. A plurality of the LEDs 224 are arranged in line along the long-side direction of the LED board 225 (the X-axis direction) and connected in series by a wiring pattern formed on the LED board 225. Intervals between the LEDs 224 are substantially constant, that is, the LEDs 224 are arranged at equal intervals. Connectors 225a are provided at ends of the long dimension of each LED board 225.

As illustrated in FIG. 13, a plurality of the LED boards 225 are arranged along the X-axis direction and a plurality of the LED boards 225 are arranged along the Y-axis direction inside the chassis 222. The long sides and the short sides of the LED boards 225 are aligned, respectively. Namely, the LED boards 225 and the LEDs 224 mounted thereon are arranged in a grid (in a matrix (or in planar arrangement) with rows and columns aligned with the X-axis direction and Y-axis direction, respectively. The X-axis direction and the Y-axis direction correspond to the long-side direction of the chassis 222 or the LED board 225 and the short-side direction of the chassis 222 or the LED board 225, respectively. Specifically, three LED boards 225 along the X-axis direction by nine LED boards 225 along the Y-axis direction and a total of twenty-seven LED boards 225 are arranged inside the chassis 222. In a row of the LED boards 225 arranged along the X-axis direction, the LED boards 225 are electrically connected each other with the adjacent connectors 225a are fitted together. Moreover, the connectors 225a at the ends of the X-dimension of the chassis 222 are electrically connected to an external control circuit, which is not illustrated. With this configuration, the LEDs 224 on the LED boards 225 in each row are connected in series and multiple LEDs 224 in the row can be turned on and off by a single control circuit. This contributes to a cost reduction. The LED boards 225 are arranged at substantially equal intervals along the Y-axis direction. Namely, the LEDs 224 in planer arrangement along the bottom plate 222a inside the chassis 222 are arranged at equal intervals with respect to the X-axis direction and the Y-axis direction.

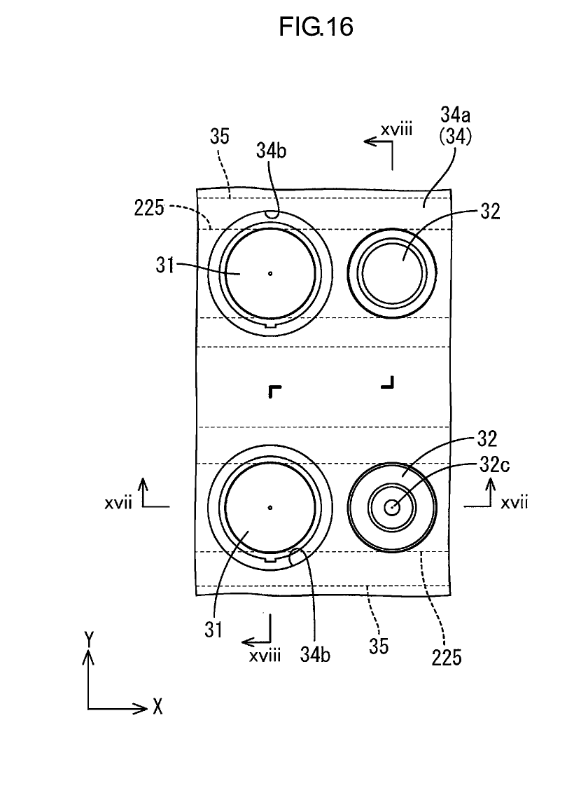

Each diffuser lens 31 is made of substantially transparent synthetic resin (highly capable of light transmission) having a refraction index higher than that of the air (e.g., poly carbonate or acrylic). As illustrated in FIGS. 16 to 18, the diffuser lens 31 has a specified thickness and a substantially round plan-view shape. The diffuser lenses 31 are mounted to the LED boards 225 so as to cover the respective LEDs 224 from the front side, namely, the diffuser lenses 31 are arranged so as to overlap the respective LEDs 224 in plan view. Each diffuser lens 31 diffuses light emitted from the LED 224 and having a strong directivity. Namely, the directivity of the light emitted from the LED 224 is reduced by the diffuser lens 31. Therefore, an area between the adjacent LEDs 224 is less likely to be recognized as a dark spot even when the adjacent LEDs 224 are arranged away from each other. With this configuration, the number of LEDs 224 can be reduced. The diffuser lenses 31 are arranged substantially concentric with the respective LEDs 224.

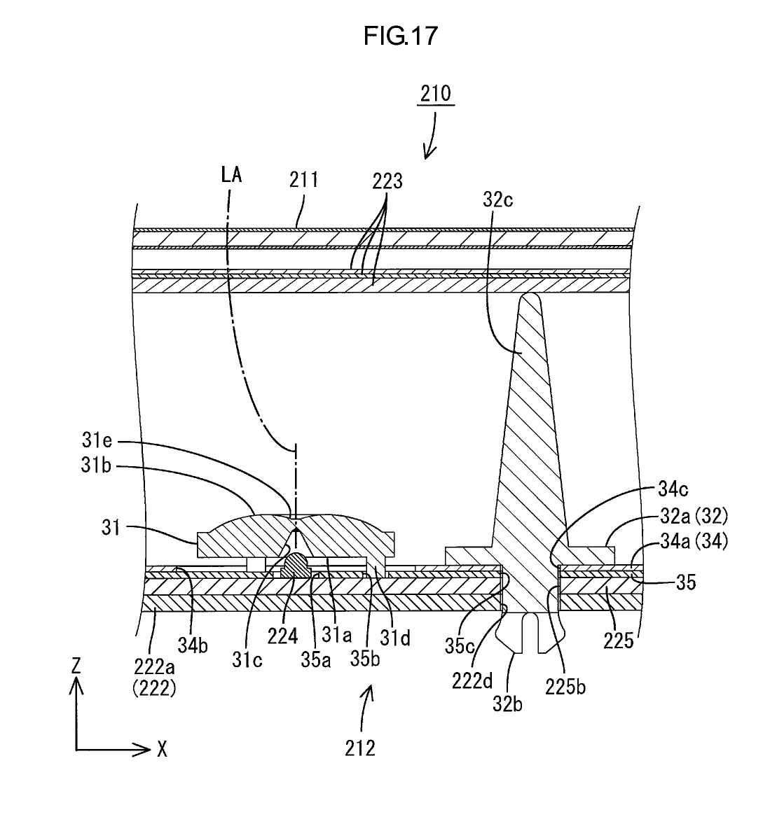

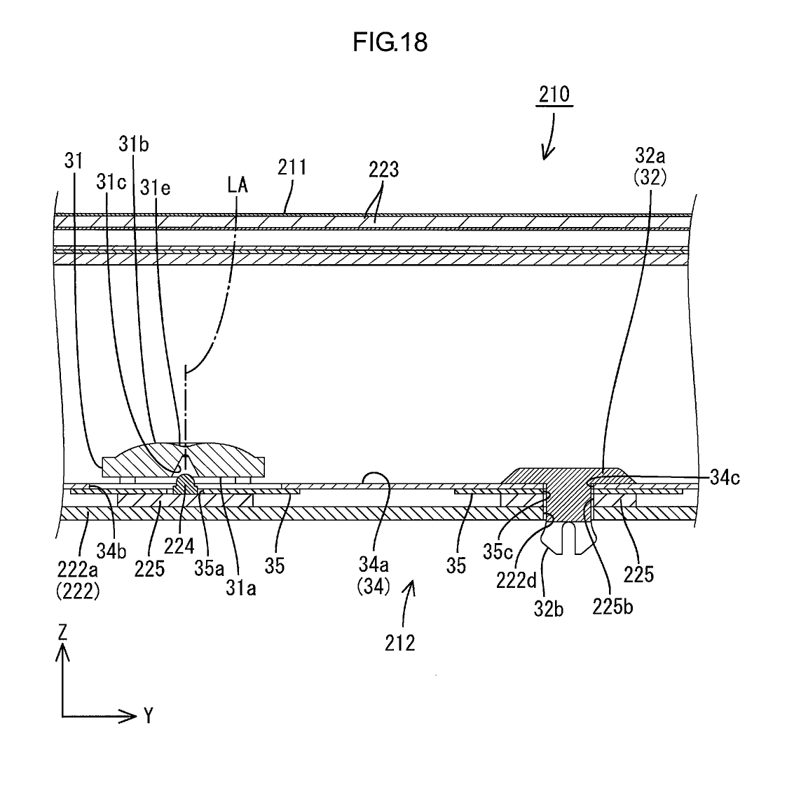

The surface of each diffuser lens 31 facing the rear side and opposite the LED board 225 (or the LED 224) is the light entrance surface 31a through which light from the LED 224 enters. The surface facing the front side and opposite the optical member 223 is the light exit surface 31b through which light exits. As illustrated in FIGS. 17 and 18, the light entrance surface 31a is generally parallel to the board surface of the LED board 225 (the X-Y plane). The diffuser lens 31 has a light entrance-side recess 31c in an area overlapping the LED 224 in plan view. Therefore, the light entrance surface 31a has a sloped portion angled to the light axis LA of the LED 224. The light entrance-side recess 31c has an inverted V-shape in cross-sectional view and a funnel-like shape. The light entrance-side recess 31c is formed substantially at the center of the diffuser lens 31. Light emitted from the LED 224 and directed to the light entrance-side recess 31c is refracted into the diffuser lens 31. Mounting legs 31e for mounting to the LED board 225 project from the light entrance surface 31a. The light exit surface 31b is formed in a gently curved spherical shape. With this configuration, light exiting from the diffuser lens 31 can be refracted at a wide angle and directed to the outside. A light exit-side recess 31e is formed in the area of the light exit surface overlapping the LED 224 in plan view. With the light exit-side recess 31e, a large number of rays of light from the LED 224 can be refracted at a wide angle and directed to the outside, or some rays of light from the LED 224 can be reflected toward the LED board 225.

Next, the retention members 32 will be explained. Each retention member 32 is made of synthetic resin, for instance, polycarbonate. The surface of the retention member is in which having high light reflectivity. As illustrated in FIGS. 16 to 18, each retention member 32 includes a main body 32a and a fixing portion 32b. The main body 32a extends along the board surface of the LED board 225. The fixing portion 32b projects from the main body 32a toward the rear, that is, toward the chassis 222. The fixing portion 32b is fixed to the chassis 222. The main body 32a has a substantially round plate-like plan view shape. The LED board 225 and the reflection sheet set 33, which will be explained next, is sandwiched between the bottom plate 222a of the chassis 222 and the main body 32a. The fixing portion 32b is passed through an insertion hole 225b and the mounting hole 222d formed in the LED board 225 and the chassis 222, respectively, at a location corresponding to the mounting position of the retention member 32, and fixed to the bottom plate 222a. As illustrated in FIG. 3, a plurality of the retention members 32 are arranged in a matrix within a plane of each LED board 225. Specifically, the retention members 32 are arranged between the adjacent diffuser lenses 31 (or the LEDs 224).

As illustrated in FIGS. 12 to 14, a pair of the retention members 32 having support portions 32c that project from the main bodies 32a is arranged in the middle area of the screen. The support portions 32c supports the optical member set 223 from the rear side. With this configuration, a positional relationship between the LEDs 224 and the optical member set 223 with respect to the Z-axis direction remains constant. Furthermore, the optical member set 223 is less likely to accidentally deform.

Next, the reflection sheet set 33 will be explained. The reflection sheet set 33 include a first reflection sheet 34 that covers a substantially entire inner surface of the chassis 222 and second reflection sheets 35 that cover the LED boards 225, respectively. The reflection sheets 34 and 35 are made of resin and the surfaces thereof are in white having high light reflectivity. The reflection sheets 34 and 35 extend along the bottom plate 222a (of the LED boards 225) within the chassis 222.

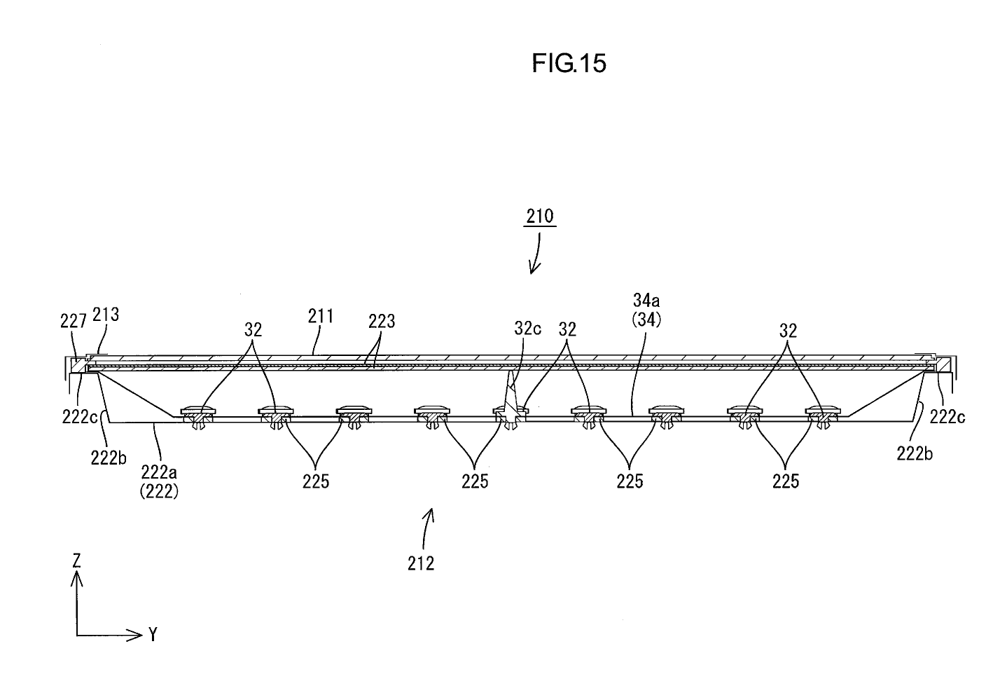

Next, the first reflection sheet 34 will be explained. As illustrated in FIG. 13, most of the middle part of the first reflection sheet 34 extending along the bottom plate 222a of the chassis 222 is a bottom portion 34a. The bottom portion 34a has lens insertion holes 34b that are through holes. Each LED 224 arranged inside the chassis 222 and the diffuser lens 31 covering the LED 224 can be inserted in the corresponding insertion hole 34b. The lens insertion holes 34b are arranged in a matrix in the bottom portion 34a so as to overlap the LEDs 224 and the diffuser lenses 31 in plan view. As illustrated in FIG. 16, each lens insertion hole 34b has a round plan view shape and a diameter larger than that of the diffuser lens 31. The bottom portion 34a also has insertion holes 34c between the adjacent lens insertion holes 34b. The fixing portions 32b of the retention members 32 are passed through the insertion holes 34c. As illustrated in FIG. 13, the first reflection sheet 34 covers areas between the adjacent diffuser lenses 31 and outer peripheral areas inside the chassis 222. Therefore, the rays of light traveling to those areas are reflected toward the optical member set 223. As illustrated in FIGS. 14 and 15, the outer peripheral portions of the first reflection sheet 34 rise so as to cover the side plates 222b and the receiving plates of the chassis 222. The portions of the first reflection sheet 34 placed on the receiving plates 222c are sandwiched between the chassis 222 and the optical member set 223. Portions of the reflection sheet 34 that connect the bottom portion 34a to the portions thereof placed on the receiving plates 222c are sloped.

As illustrated in FIG. 16, each second reflection sheet 35 has a rectangular plan view shape substantially similar to the LED board 225. As illustrated in FIGS. 17 and 18, the second reflection sheet 35 is arranged so as to overlap the front surface of the LED board 225 and opposed to the diffuser lens 31. Namely, the second reflection sheet 35 is arranged between the diffuser lens 31 and the LED board 225. Rays of light returned from the diffuser lens 31 to the LED board 225 or traveling from areas outer than the diffuser lens 31 in plan view to an area between the diffuser lens 31 and the LED board 225 are reflected to the diffuser lens 31 by the second reflection sheet 35. With this configuration, the light use efficiency can be improved and thus the brightness can be improved. Namely, sufficient brightness can be achieved even when the number of the LEDs 224 is reduced to improve cost performance.

Each second reflection sheet 35 has a landscape rectangular plan view shape similar to the corresponding LED board 225 and thus can cover an entire area of the LED board 225 from the front side. As illustrated in FIGS. 16 and 18, the second reflection sheet 35 has a short-side dimension larger than the LED board 225. Moreover, the short-side dimension is larger than the diameters of the diffuser lens 31 and the lens insertion hole 34b of the first reflection sheet 34. Therefore, the edge of the lens insertion hole 34b of the first reflection sheet 34 is located on the second reflection sheet 34 on the front side. With this configuration, the first reflection sheet 34 and the second reflection sheets 35 are continuously arranged without gaps in plan view. Namely, the chassis 222 and the LED boards 225 are less likely to be exposed to the front side through the lens insertion holes 34b. Therefore, rays of light inside the chassis 222 can be efficiently reflected toward the optical member set 223. This configuration is very preferable for improving the brightness. The second reflections sheets 35 has LED insertion holes 35a, leg insertion holes 35b, and insertion holes 35c formed so as to overlap in plan view, respectively. The LEDs 224 are passed through the LED insertion holes 35a. Mounting legs of the diffuser lenses 31 are passed through the leg insertion holes 35b. The fixing portions 32b of the retention members 32 are passed through the insertion holes 35c.

### Other Embodiments

The embodiments according to the present invention have been described. The present invention is not limited to the embodiments explained in the above description with reference to the drawings. The following embodiments may be included in the technical scope of the present invention, for example.

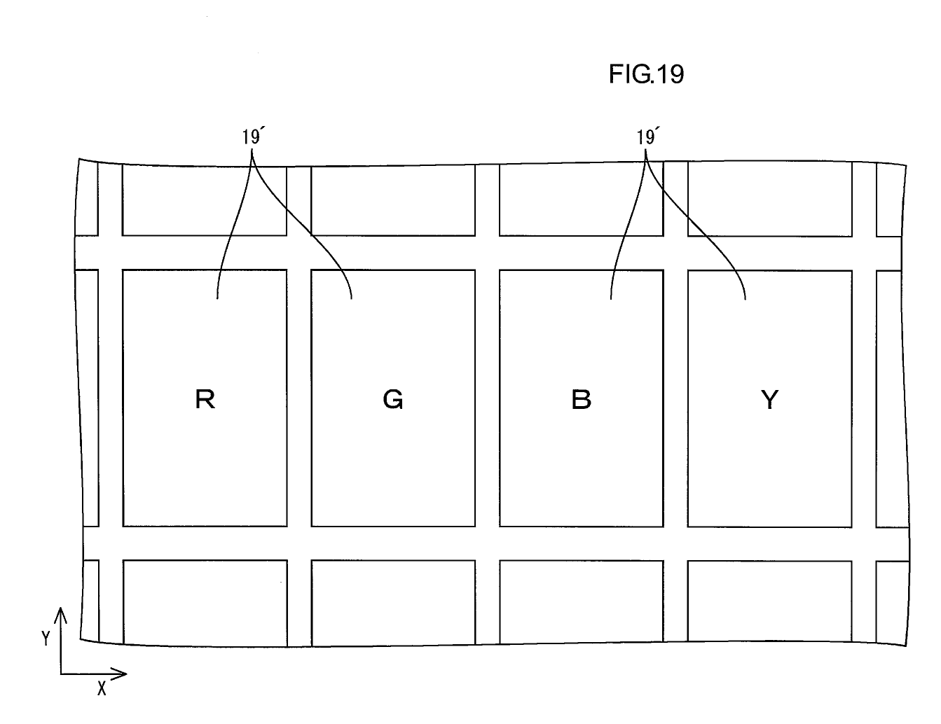

(1) The arrangement of the color portions of the color filters of the liquid crystal panel can be altered from that in the first embodiment as appropriate. Color filters 19′ illustrated in FIG. 19 may be included in the scope of the present invention. R, G, B, Y color portions of the color filters are arranged such that the R color portion in red, the green color portion in green, the blue color portion in blue, and the yellow color portion in yellow are arranged in this sequence from the left side in FIG. 19 along the X-axis direction.

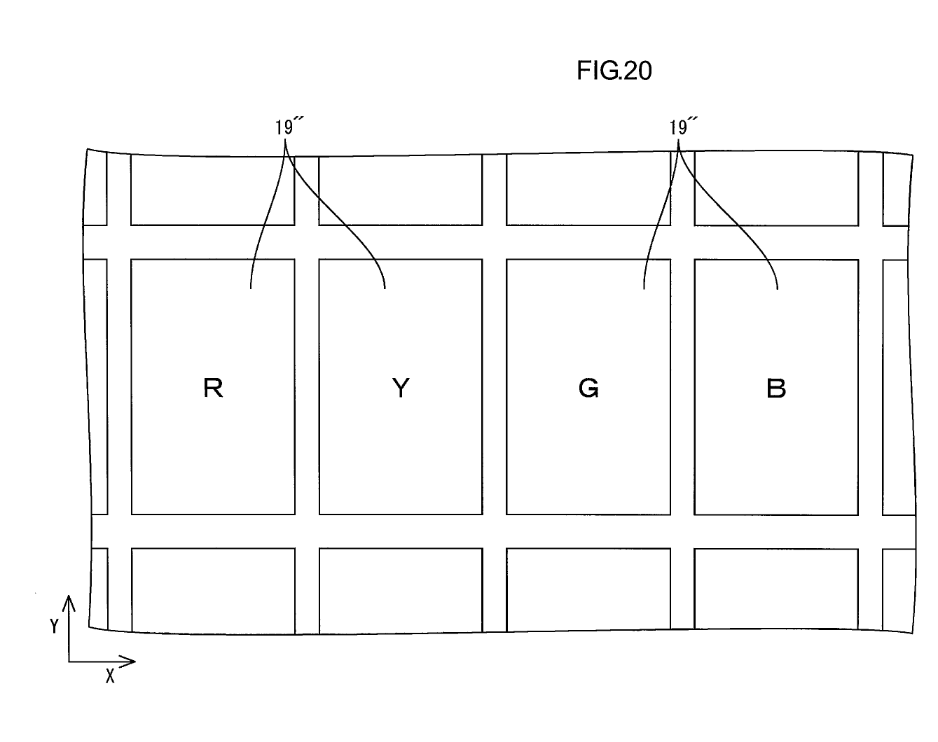

(2) Color filters 19″ in FIG. 20 may be included in the scope of the present invention other than the above embodiment (1). R, G, B, Y color portions of the color filters are arranged such that the R color portion in red, the yellow color portion in yellow, the green color portion in green, and the blue color portion in blue are arranged in this sequence from the left side in FIG. 19 along the X-axis direction.

(3) In the first embodiment, one kind of the green phosphors and one kind of the red phosphors are used for the phosphors included in the LEDs. However, multiple kinds of phosphors may be used for one color of phosphors regarding both or one of the green phosphor and the red phosphor. Such a configuration may be included in the scope of the present invention. This configuration is applicable for the second embodiment including the yellow phosphor and the red phosphor as phosphors.

(4) In the first embodiment, the green phosphor and the red phosphor are used as phosphors included in the LEDs. In the second embodiment, the yellow phosphor and the red phosphor are used as phosphors included in the LEDs. However, the green phosphor, the yellow phosphor, and the red phosphor may be used for the phosphors included in the LEDs. Specifically, the following phosphors may be used for the phosphors. β-SiAlON may be used for the green phosphor. A BOSE-based phosphor, an α-SiAlON-based phosphor, or a YAG-based phosphor may be used for the yellow phosphor. A CaAlSiN-based phosphor may be used for the red phosphor. A combination of the above phosphors is preferable. Multiple kinds of phosphors may be used for one color of phosphors as described in the above embodiment (3).

(5) Other than the first embodiment, the second embodiment, and the above embodiment (4), only the green phosphor and the yellow phosphor may be used as the phosphors included in the LEDs and the red phosphor may not be used. Alternately, only the yellow phosphor may be used as the phosphor included in the LEDs and the green phosphor and the red phosphor may not be used.

(6) In the above embodiments, each LED includes the single light emitting LED chip configured to emit blue light and is configured to produce substantially white light (including white light and bluish white light) using phosphors. However, LEDs each including a single light emitting LED chip configured to emit ultraviolet light (bluish violet light) and is configured to white light using phosphors may be used. With such LEDs, the chromaticity of the LEDs can be adjusted by adjusting contents of the phosphors in the LEDs.

(7) In the above embodiments, each LED includes the single light emitting LED chip configured to emit blue light and is configured to white light (including white light and bluish white light) using phosphors. However, LEDs each including three kinds of single light emitting LED chips may be used. The single light emitting diodes may emit R, G, and B colors of light, respectively. Alternatively, LEDs each including three other kinds of single light emitting LED chips may be used. The single light emitting diodes may emit cyan (C), magenta (M), and yellow (Y) colors of light, respectively. With such LEDs, the chromaticity of the LEDs can be adjusted by adjusting contents of the phosphors in the LEDs.

(8) In the first embodiment, the LED boards (or the LEDs) are arranged at the long edges of the chassis (or the light guide member), respectively. However, the LED boards (or the LEDs) are arranged at the short edges of the chassis (or the light guide member), respectively.

(9) Other than the above embodiment (8), the LED boards (or the LEDs) may be arranged at the long edges and the short edges of the chassis (or the light guide member), respectively. Furthermore, the LED boards (or the LEDs) may be arranged at one of the long edges and at one of the short edges, respectively.

(10) The liquid crystal panel and the chassis are set in the vertical position with the short-side directions thereof aligned with the vertical direction. However, the liquid crystal panel and the chassis may be set in the vertical position with a long-side direction thereof aligned with the vertical direction.

(11) In the above embodiments, the TFTs are used as switching components of the liquid crystal display device. However, the technology described herein can be applied to liquid crystal display devices using switching components other than TFTs (e.g., thin film diodes (TFDs)). Furthermore, it can be applied to black-and-white liquid crystal display devices other than the color liquid crystal display device.

(12) In the above embodiments, the liquid crystal display device including the liquid crystal panel as a display panel is used. However, the present invention can be applied to display devices including other types of display panels.

(13) In the above embodiments, the television receiver including the tuner is used. However, the technology can be applied to a display device without the tuner.

### EXPLANATION OF SYMBOLS

10, 110, 210: Liquid crystal display device (Display device), 11, 116, 211: Liquid crystal panel (Display panel), 11a: CF substrate, 11b: Array substrate, 11c: Liquid crystal layer (Substances, liquid crystals), 12, 124, 212: Backlight unit (Lighting unit), 19: Color filter, 24, 224: LED, 24a: Blue LED chip (LED element), 26, 120: Light guide member, 26b; Light entrance surface, 28: First reflection sheet, 29: Second reflection sheet, 30: Lens, R: Red color portion, G: Green color portion, B: Blue color portion, Y: Yellow color portion, TV: Television receiver, VC: Image converter circuit.

1. A display device comprising:
a display panel including a pair of substrates, a substance having optical characteristics varying according to an application of electric field and arranged between the substrates, color filters formed on one of the substrates, the color filters including a plurality of color portions in blue, green, red and yellow, respectively; and
a lighting unit configured to illuminate the display panel, the lighting unit including LEDs as light sources.

2. The display device according to claim 1, wherein each LED includes an LED element as a light emitting source and a phosphor configured to emit light exited by light from the LED element.

3. The display device according to claim 2, wherein
the LED element is a blue LED element configured to emit blue light, and
the phosphor includes a red phosphor and at least one of a green phosphor and a yellow phosphor, the red phosphor being configured to emit red light excited by the blue light, the green phosphor being configured to emit green light excited by the blue light, the yellow phosphor being configured to emit yellow light excited by the blue light.

4. The display device according to claim 3, wherein the at least one of the green phosphor and the yellow phosphor is a SiAlON-based phosphor.

5. The display device according to claim 4, wherein the green phosphor is β-SiAlON.

6. The display device according to claim 4, wherein the yellow phosphor is α-SiAlON.

7. The display device according to claim 3, wherein the red phosphor is a CaAlSiN-based phosphor.

8. The display device according to claim 7, wherein the CaAlSiN-based phosphor of the red phosphor is expressed by CaAlSiN₃:Eu.

9. The display device according to claim 3, wherein the at least one of the green phosphor and the yellow phosphor is a YAG-based phosphor.

10. The display device according to claim 3, wherein the yellow phosphor is a BOSE-based phosphor.

11. The display device according to claim 1, wherein the lighting unit includes a light guide member made of synthetic resin and arranged opposite an end of each LED, the light guide member being configured to pass light emitted from the LED and direct the light toward the display panel.

12. The display device according to claim 11, wherein
the light guide member has a longitudinal light entrance surface at an end thereof on an LED side, and
each LED has a lens covering a light emitting side thereof and diffusing light, the lens being opposite the light entrance surface of the light guide member and curved along a longitudinal direction of the light entrance surface so as to protrude toward the light guide member.

13. The display device according to claim 12, wherein the lighting unit includes a reflection sheet arranged between the LEDs and the light guide member along the longitudinal direction of the light entrance surface.

14. The display device according to claim 1, wherein the display panel is a liquid crystal panel including liquid crystals as substances that vary optical characteristics according to an application of electric field.

15. A television receiver comprising:
the display device according to claim 1; and
a receiver configured to receive a television signal.

16. The television receiver according to claim 15, further comprising an image converter circuit configured to convert a television signal output from the receiver into blue, green, red and yellow image signals.
